(19) United States
(12) Patent Application Publication
(10) Pub. No.: US 2026/0161664 A1
(43) Pub. Date: Jun. 11, 2026

(54) ELECTRONIC DEVICE INCLUDED IN BLOCKCHAIN NETWORK AND OPERATION METHOD THEREOF

(71) Applicant: SAMSUNG ELECTRONICS CO., LTD., Suwon-si (KR)

(72) Inventors: Jiwon LEE, Suwon-si (KR); Jongtak LEE, Suwon-si (KR); Jaewoo SEO, Suwon-si (KR); Hyeongseob KIM, Suwon-si (KR); Wonhyuk KANG, Suwon-si (KR)

(73) Assignee: SAMSUNG ELECTRONICS CO., LTD., Suwon-si (KR)

(21) Appl. No.: 19/416,862

(22) Filed: Dec. 11, 2025

Related U.S. Application Data
(63) Continuation of application No. PCT/KR2025/021383, filed on Dec. 11, 2025.

(30) Foreign Application Priority Data
Dec. 11, 2024 (KR) 10-2024-0183429
Jan. 23, 2025 (KR) 10-2025-0010493

(51) Int. Cl. G06F 16/27; G06F 16/23

(52) U.S. Cl. CPC G06F 16/273; G06F 16/2379

(57) ABSTRACT

An electronic device corresponding to one node of nodes included in a blockchain network. The electronic device to request the server to add a new block in the nodes. The electronic device to extract, using a communication circuitry, transaction information on last blocks in a number corresponding to a specified transaction capacity from the nodes. The electronic device to generate new transaction information. The electronic device to transmit information related to a consensus to initialize blocks previously stored in the nodes. The electronic device to transmit the new transaction information to the server. The electronic device to based on a consensus on adding the new block being successful, add the new block to the memory in a state where previously accumulated blocks have been removed from the memory.

### CROSS-REFERENCE TO RELATED APPLICATIONS

This application is a continuation of International Application No. PCT/KR2025/021383, filed on Dec. 11, 2025, which is based on and claims priority to Korean Patent Application No. 10-2024-0183429, filed on Dec. 11, 2024, in the Korean Intellectual Property Office, and Korean Patent Application No. 10-2025-0010493, filed on Jan. 23, 2025, in the Korean Intellectual Property Office, the disclosures of which are incorporated by reference herein in their entireties.

### BACKGROUND

### 1. Field

The disclosure relates to an electronic device included in a blockchain network and an operation method thereof.

### 2. Description of Related Art

Since the release of Bitcoin based on blockchain, blockchain has been applied not only to electronic currency (e.g., cryptocurrency or virtual currency) systems like Bitcoin, but also to various fields such as smart contract-based platform provision services, services for managing and trading creative works through non-fungible tokens (NFTs), cloud storage services, and blockchain computing services.

A blockchain platform allows members (e.g., nodes) participating in a system to distribute and store data in respective blocks. Thereby making data tampering or falsification virtually impossible, enabling each member to hold distributed information, and requiring no central server administrator.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

According to an embodiment of the disclosure, an electronic device corresponding to one of nodes included in a blockchain network includes communication circuitry, at least one processor including processing circuitry, and memory configured to store instructions.

The technical task to be achieved by the disclosure is not limited to that mentioned above, and other technical tasks that are not mentioned above may be clearly understood to a person having common knowledge in the technical field to which the disclosure belongs.

According to an embodiment of the disclosure, an electronic device corresponding to one node of nodes included in a blockchain network. The electronic device including: communication circuitry; at least one processor including processing circuitry; and memory configured to store instructions. The instructions, when executed by the at least one processor individually or collectively, cause the electronic device to: receive, using the communication circuitry, information on a block lastly stored in the nodes included in the blockchain network. The information is transmitted by a server configured to relay message transmissions between the nodes. The electronic device to identify a number of blocks accumulated in the memory based on the information. The electronic device to, based on the number of blocks being equal to a specified block capacity, request the server to add a new block in the nodes. The electronic device to extract, using the communication circuitry, transaction information on last blocks in a number corresponding to a specified transaction capacity from the nodes. The electronic device to generate new transaction information, based on the extracted transaction information. The electronic device to transmit, to the server, information related to a consensus to initialize blocks previously stored in the nodes. The electronic device to transmit the new transaction information to the server to allow the new transaction information, which is to be stored in the new block, to be transmitted to the nodes via the server. The electronic device to, based on a consensus on adding the new block being successful, add the new block to the memory in a state where previously accumulated blocks have been removed from the memory.

In an embodiment, the new block includes a key, a newly assigned block number, an updated leaf index, and the transaction information including a value for the key.

In an embodiment, the instructions, when executed by the at least one processor individually or collectively, cause the electronic device to: based on the number corresponding to the transaction capacity being equal to or greater than 2, compress transaction information on two or more blocks lastly stored. The new transaction information is generated based on the compressed transaction information. A newly assigned block number is identically reflected on the transaction information on the two or more blocks.

In an embodiment, the instructions, when executed by the at least one processor individually or collectively, cause the electronic device to: based on blocks lastly stored in the nodes being identified as differing from each other, transmit, to the server, a message requesting a match of the blocks lastly stored in the nodes.

In an embodiment, the instructions, when executed by the at least one processor individually or collectively, cause the electronic device to: based on the number of blocks being not equal to the specified block capacity, request the server to add a second new block in the nodes; based on identifying, through the server, that a new node has been added to the blockchain network, identify version information for synchronization between the nodes included in the blockchain network through the server; based on identifying that the version information of the new node is a lower version, transmit information related to a consensus to perform synchronization based on the lower version to the server; and based on a second consensus on adding the second new block being successful, add the second new block of the lower version to the memory in a state where previously accumulated blocks of a higher version have been removed from the memory.

In an embodiment, the instructions, when executed by the at least one processor individually or collectively, cause the electronic device to: based on the information on the block lastly stored, identify that a block number of the last block does not exceed a specified range and synchronization between the nodes has failed; based on identifying that the block number of the last block does not exceed the specified range and that the synchronization between the nodes has failed, identify a stable number and an unstable number; based on blocks of a second node having the stable number, recover a block of a first node having the unstable number, the block of the first node to have a stable number during a next consensus and synchronization; request, through the server, a consensus to add a second new block to each of the nodes, based on the stable number; and based on the consensus to add the second new block to each of the nodes being successful, add the second new block to the memory.

According to an embodiment of the disclosure, an operation method of an electronic device corresponding to one node of nodes included in a blockchain network. The method including receiving, using communication circuitry of the electronic device, information on a block lastly stored in the nodes included in the blockchain network. the information is transmitted by a server configured to relay message transmissions between the nodes. The method including identifying a number of blocks accumulated in the memory based on the information. The method including, based on the number of blocks being equal to a specified block capacity, requesting the server to add a new block in the nodes. The method including extracting, using the communication circuitry, transaction information on last blocks in a number corresponding to a specified transaction capacity from the nodes. The method including generating new transaction information, based on the extracted transaction information. The method including transmitting, to the server, information related to a consensus to initialize blocks previously stored in the nodes. The method including transmitting the new transaction information to the server to allow the new transaction information, which is to be stored in the new block, to be transmitted to the nodes via the server. The method including, based on a consensus on adding the new block being successful, adding the new block to the memory in a state where previously accumulated blocks have been removed from the memory.

In an embodiment, the new block includes a key, a newly assigned block number, an updated leaf index, and the transaction information including a value for the key.

In an embodiment, the generating of the new transaction information includes: based on the number corresponding to the transaction capacity being equal to or greater than 2, compressing transaction information on two or more blocks lastly stored. The new transaction information is generated based on the compressed transaction information. A newly assigned block number is identically reflected on the transaction information on the two or more blocks.

In an embodiment, the method further includes, based on blocks lastly stored in the nodes being identified as differing from each other, transmitting, to the server, a message requesting a match of the blocks lastly stored in the nodes.

In an embodiment, the method further includes, based on the number of blocks being not equal to the specified block capacity, requesting the server to add second a new block in the nodes; based on identifying, through the server, that a new node has been added to the blockchain network, identifying version information for synchronization between the nodes included in the blockchain network through the server; based on identifying that the version information of the new node is a lower version, transmitting information related to a consensus to perform synchronization based on the lower version to the server; and based on a second consensus on adding the second new block being successful, adding the second new block of the lower version to the memory in a state where previously accumulated blocks of a higher version have been removed from the memory.

In an embodiment, the method further includes, based on the information on the block lastly stored, identifying that a block number of the last block does not exceed a specified range and synchronization between the nodes has failed; based on identifying that the block number of the last block does not exceed the specified range and that the synchronization between the nodes has failed, identifying a stable number and an unstable number; based on blocks of a second node having the stable number, recovering a block of a first node having the unstable number, the block of the first node to have a stable number during a next consensus and synchronization; requesting, through the server, a consensus to add a second new block to each of the nodes, based on the stable number; and based on the consensus to add the second new block to each of the nodes being successful, adding the second new block to the memory.

According to an embodiment of the disclosure, a non-transitory storing medium storing one or more programs, the programs including instructions which, when executed by at least one processor of an electronic device individually or collectively, cause the electronic device to execute operations of: receiving, using communication circuitry of the electronic device, information on a block lastly stored in the nodes included in the blockchain network. The information is transmitted by a server configured to relay message transmissions between the nodes. The electronic device to execute operations of: identifying a number of blocks accumulated in the memory based on the information. The electronic device to execute operations of: based on the number of blocks being equal to a specified block capacity, requesting the server to add a new block in the nodes. The electronic device to execute operations of: extracting, using the communication circuitry, transaction information on last blocks in a number corresponding to a specified transaction capacity from the nodes. The electronic device to execute operations of: generating new transaction information, based on the extracted transaction information. The electronic device to execute operations of: transmitting, to the server, information related to a consensus to initialize blocks previously stored in the nodes. The electronic device to execute operations of: transmitting the new transaction information to the server to allow the new transaction information, which is to be stored in the new block, to be transmitted to the nodes via the server. The electronic device to execute operations of: based on a consensus on adding the new block being successful, adding the new block to the memory in a state where previously accumulated blocks have been removed from the memory.

In an embodiment, the programs includes a instruction which, when executed by the at least one processor of the electronic device, cause the electronic device to execute an operation of: based on the number corresponding to the transaction capacity being equal to or greater than 2, compressing transaction information on two or more blocks lastly stored. The new transaction information is generated based on the compressed transaction information. A newly assigned block number is identically reflected on the transaction information on the two or more blocks.

In an embodiment, the programs includes a instruction which, when executed by the at least one processor of the electronic device, cause the electronic device to execute an operation of: based on blocks lastly stored in the nodes being identified as differing from each other, transmitting, to the server, a message requesting a match of the blocks lastly stored in the nodes.

According to an embodiment of the disclosure, an electronic device corresponding to one node of nodes included in a blockchain network. The electronic device including: communication circuitry; at least one processor including processing circuitry; and memory configured to store instructions. The instructions, when executed by the at least one processor individually or collectively, cause the electronic device to: receive, using the communication circuitry, information on a block lastly stored in the nodes included in the blockchain network. The information is transmitted by a server configured to relay message transmissions between the nodes. The electronic device to: based on the identified information on the block, request the server to add a new block in the nodes. The electronic device to: based on identifying, through the server, that a new node has been added to the blockchain network, identify version information for synchronization between the nodes included in the blockchain network through the server. The electronic device to: based on identifying that the version information of the new node is a lower version, transmit information related to a consensus to perform synchronization based on the lower version to the server. The electronic device to: based on a consensus on adding the new block being successful, add the new block of the lower version to the memory in a state where previously accumulated blocks of a higher version have been removed from the memory.

In an embodiment, the new block of the lower version includes a key, a newly assigned block number, an updated leaf index, and the transaction information including a command of the lower version including a value for the key. The newly assigned block number is newly assigned starting from a start number of a next range for a specified block capacity.

In an embodiment, the instructions, when executed by the at least one processor individually or collectively, cause the electronic device to: generate the transaction information including the command of the lower version; and transmit the generated transaction information and signature information to the server using the communication circuitry.

According to an embodiment of the disclosure, an electronic device that is one node of one or more nodes included in a blockchain network. The electronic device including: communication circuitry; at least one processor including processing circuitry; and memory configured to store instructions. The instructions, when executed by the at least one processor individually or collectively, cause the electronic device to: receive, using the communication circuitry, information on a block lastly stored in each of nodes included in the blockchain network. The information is transmitted by through a server configured to relay message transmissions between the nodes. The electronic device to: based on synchronization between the nodes having failed, identify a stable number and an unstable number. The electronic device to: based on blocks of a second node having the stable number, recover a block of a first node having the unstable number, the block of the first node to have a stable number during a next consensus and synchronization. The electronic device to: request, through the server, a consensus to add a new block to each of the nodes, based on the stable number. The electronic device to: based on the consensus being successful, add the new block to the memory.

In an embodiment, the instructions, when executed by the at least one processor individually or collectively, cause the electronic device to: based on a block number of the next consensus matches the unstable number, add a dummy block corresponding to the unstable number and request a consensus by using a number next to the unstable number.

### BRIEF DESCRIPTION OF THE DRAWINGS

FIG. 1 is a block diagram of an electronic device in a network environment according to various embodiments.

FIG. 2A is a diagram illustrating an electronic system according to an embodiment.

FIG. 2B is a block diagram of a server and nodes included in a blockchain network according to an embodiment.

FIGS. 3A-3F are diagrams illustrating a method for adding a new block by an electronic device included in a blockchain network according to an embodiment.

FIG. 4 is a diagram illustrating information related to a block according to an embodiment.

FIG. 5 is a diagram illustrating an example for performing, by an electronic device included in a blockchain network, data cleanup for blocks accumulated in memory when a new block exceeding a block capacity is added according to an embodiment.

FIG. 6 is a diagram illustrating an example for performing, by an electronic device included in a blockchain network, data cleanup for blocks accumulated in memory when a new block exceeding a block capacity is added according to an embodiment.

FIG. 7A and FIG. 7B are diagrams illustrating an example of a table for a state map stored in a server included in a blockchain network according to an embodiment.

FIG. 8 is a diagram illustrating an example for performing, by an electronic device included in a blockchain network, data cleanup for higher-version blocks accumulated in memory when a lower-version node is added according to an embodiment.

FIGS. 9A-9D are diagrams illustrating examples for operating a blockchain in an electronic device included in a blockchain network according to an embodiment.

FIG. 10 is a flowchart illustrating a method for performing, by an electronic device included in a blockchain network, data cleanup for blocks accumulated in memory when a new block exceeding a block capacity is added according to an embodiment.

FIG. 11 is a flowchart illustrating a method for performing, by an electronic device included in a blockchain network, data cleanup for higher-version blocks accumulated in memory when a lower-version node is added according to an embodiment.

FIG. 12 is a flowchart illustrating a method for operating a blockchain in an electronic device included in a blockchain network according to an embodiment.

In relation to the description of drawings, the same or similar elements may be indicated by the same or similar reference signs.

### DETAILED DESCRIPTION

Hereinafter, embodiments of the disclosure will be described in detail with reference to the drawings so that a person having common knowledge in the technical field to which the disclosure belongs are able to readily carry out the disclosure. However, the disclosure may be implemented in any of various forms, and should not be construed as being limited to the embodiments set forth herein. In relation to the description of drawings, the same or similar elements may be indicated by the same or similar reference signs. In addition, in the drawings and related descriptions, description of well-known functions and configurations may be omitted of clarity and briefness. The term “user” used in an embodiment of the disclosure may refer to a person using an electronic device or a device (e.g., an artificial intelligence electronic device) using the electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

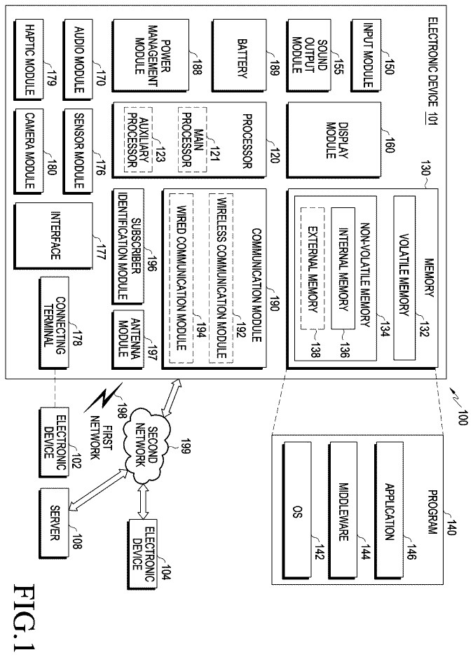

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

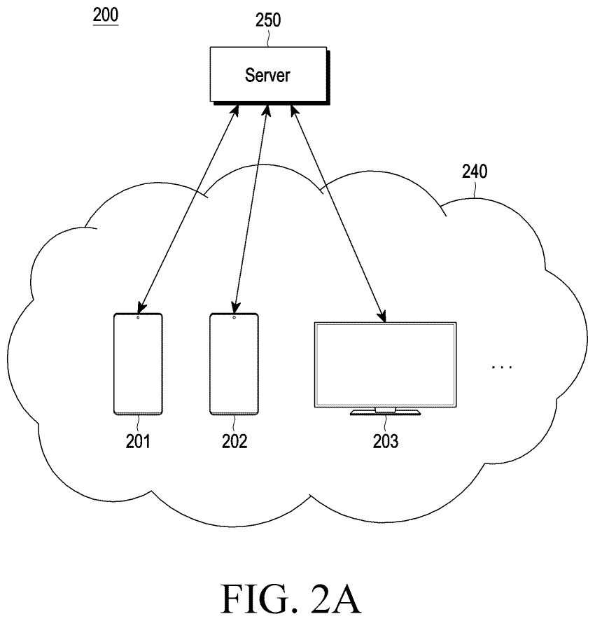

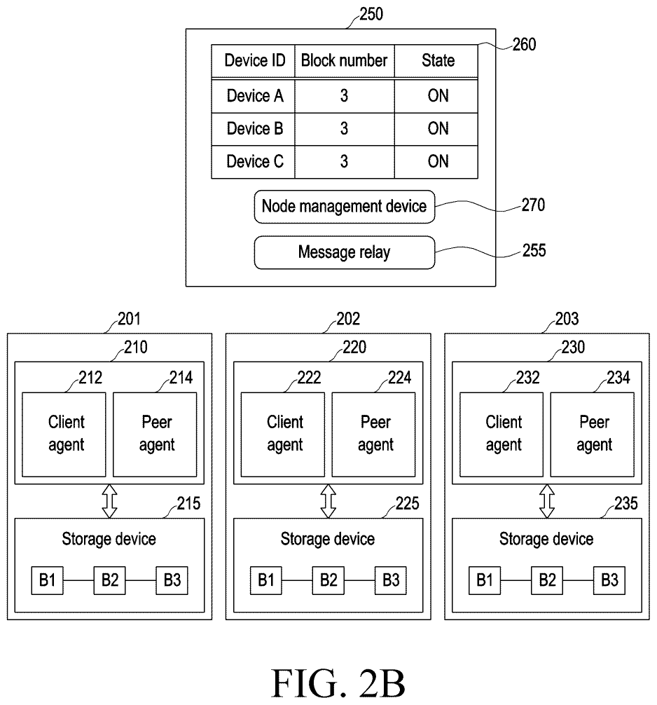

FIG. 2A is a diagram briefly illustrating an electronic system according to an embodiment.

Referring to FIG. 2A, an electronic system 200 may include multiple electronic devices 201, 202, and 203 and a server 250.

According to an embodiment, the multiple electronic devices 201, 202, and 203 may be implemented as nodes of a blockchain network 240. For example, the multiple electronic devices 201, 202, and 203 may include various types of electronic devices. Although the multiple electronic devices 201, 202, and 203 are illustrated as two smartphones and one TV in FIG. 2A, this merely corresponds to an illustrative example, and the number or types of electronic devices may not be limited thereto.

According to an embodiment, the server 250 may be configured to relay message transmissions between nodes (e.g., the multiple electronic devices 201, 202, and 203) included in the blockchain network 240. For example, the nodes 201, 202, and 203 included in the blockchain network 240 may transmit and receive information through the server 250.

According to an embodiment, the server 250 may provide information on the latest block included in the blockchain network 240 to each of the nodes 201, 202, and 203. For example, the information on the latest block may include information on the number of a block lastly added and stored by each of the nodes 201, 202, and 203. In addition, the server 250 may provide information (e.g., information indicating whether a corresponding node is currently in an on state or off state) indicating the states of the nodes 201, 202, and 203 included in the blockchain network 240. For example, the nodes 201, 202, and 203 included in the blockchain network 240 may access the server 250 and read or identify the above information provided by the server 250.

According to an embodiment, the server 250 may manage nodes included in the blockchain network 240. According to an embodiment, the server 250 may support a mutual exclusion (mutex) function for preventing a consensus conflict between the nodes 201, 202, and 203 included in the blockchain network 240. According to an embodiment, the server 250 may determine a consensus condition of the nodes 201, 202, and 203 included in the blockchain network 240. For example, the server 250 may minimize a consensus condition of the nodes 201, 202, and 203 included in the blockchain network 240.

According to an embodiment, the server 250 may include at least one device (e.g., a control device, a storage device, and a management device). According to implementation, the server 250 may be implemented as a group of multiple servers.

The elements and operations of the electronic system 200 described with reference to FIG. 2A will be described in more detail with reference to the following drawings. Hereinafter, for convenience of explanation, the electronic devices 201, 202, and 203 corresponding to nodes included in the blockchain network 240 will be described as the nodes included in the blockchain network 240. In addition, the description will be given referencing the first electronic device 201 as a client requesting addition of a new block.

FIG. 2B is a block diagram of a server and nodes included in a blockchain network according to an embodiment.

Referring to FIG. 2B, each of the electronic devices 201, 202, and 203 corresponding to nodes included in a blockchain network (e.g., the blockchain network 240 in FIG. 2A), according to an embodiment, may include a control device 210, 220, or 230. Each of the electronic devices 201, 202, and 203 may further include a storage device 215, 225, or 235 that is configured to store information on a block.

According to an embodiment, the control device 210, 220, or 230 may include at least one processor in hardware. According to implementation, the control device 210, 220, or 230 may further include communication circuitry configured to transmit and receive information (e.g., data related to a block, transaction information, and a signature) to and from the server 250.

According to an embodiment, the control device 210, 220, or 230 may execute a client agent 212, 222, or 232 and a peer agent 214, 224, or 234. For example, each of the client agent 212, 222, or 232 and the peer agent 214, 224, or 234 may be implemented as in software or as a module in which hardware and software are combined. According to implementation, the control device 210, 220, or 230 may execute only the client agent 212, 222, or 232. In this case, the client agent 212, 222, or 232 may be configured to perform an operation of the peer agent 214, 224, or 234 together.

According to an embodiment, the client agent 212, 222, or 232 may perform a series of operations related to data of each of the nodes 201, 202, and 203. For example, the client agent 212, 222, or 232 may transmit and receive data or a message to or from the server 250. For example, the client agent 212, 222, or 232 may transmit a request for adding a new block to the server 250. In addition, the client agent 212, 222, or 232 may transmit transaction information to be included in a new block to the server 250.

According to an embodiment, the peer agent 214, 224, or 234 may control and manage the storage device 215, 225, or 235. For example, the peer agent 214, 224, or 234 may provide data related to data (e.g., information on a block) stored in the storage device 215, 225, or 235. Alternatively, the peer agent 214, 224, or 234 may add and store a new block in the storage device 215, 225, or 235.

According to an embodiment, the storage device 215, 225, or 235 may store multiple blocks (e.g., B1, B2, and B3) agreed by the nodes included in the blockchain network 240. In addition, the storage device 215, 225, or 235 may store information (e.g., information related to a signature) related to the blockchain network 240. For example, the stored information may include the number of a latest block lastly stored in the storage device 215, 225, or 235 that may be “3.” For example, the storage device 215, 225, or 235 may include at least one memory.

The server 250 according to an embodiment may include a message relay 255 and a table 260. The server 250 may further include a control device hat controls overall operations of the server 250.

According to an embodiment, the message relay 255 may relay and transfer a message or information between the nodes 201, 202, and 203 included in the blockchain network 240. For example, the message relay 255 may include communication circuitry (e.g., the communication module 190 in FIG. 1) that supports wireless communication technology.

According to an embodiment, the message relay 255 may support a mutex function. For example, the mutex function may include a function by which the server 250 provides a priority related to an operation of adding a new block to a node that has requested the addition of the new block. For example, the server 250 may, when a priority related to an operation of adding a new block is assigned to a particular node, reject a request from another node while the particular node is adding the new block. According to an embodiment, the server 250 may further support a timer function for the mutex function. For example, the server 250 may assign a priority to a particular node and then configure a timer so as to limit the time for which the priority is granted. Alternatively, the server 250 may restrict a particular node from being assigned a priority a specified number of times in a row.

According to an embodiment, the table 260 may display or provide information on the latest block stored in each of the nodes included in the blockchain network 240. For example, the nodes 201, 202, and 203 included in the blockchain network 240 may access the server 250 and read or identify the information on the latest block of each of the nodes 201, 202, and 203, recorded in the table 260.

According to an embodiment, the table 260 may include device identification information (e.g., device ID), a latest block number, and state information of a node. For example, the table 260 may represent that the latest block number of the first electronic device 201 (e.g., device A) is “3,” and the state is “ON.” The table 260 may represent that the latest block number of the second electronic device 202 (e.g., device B) is “3,” and the state is “ON.” The table 260 may represent that the latest block number of the third electronic device 203 (e.g., C) is “3,” and the state is “ON.” However, the above contents of the table 260 correspond to an illustrative example, and the technical concept of the disclosure may not be limited thereto.

According to an embodiment, the server 250 may further include a node management device 270 configured to manage the nodes 201, 202, and 203 included in the blockchain network 240. The node management device 270 may determine a consensus condition (e.g., fault tolerance) of the nodes included in the blockchain network 240. For example, the node management device 270 may determine a consensus condition for adding a new block to the nodes included in the blockchain network 240. As another example, the node management device 270 may relax or adjust a consensus condition to enable addition of a new block, based on only a consensus of a specified number of nodes rather than a consensus of all nodes.

According to implementation, the server 250 may also store, a storage device connected to the server 250, information on a block stored in each of the nodes 201, 202, and 203 included in the blockchain network 240.

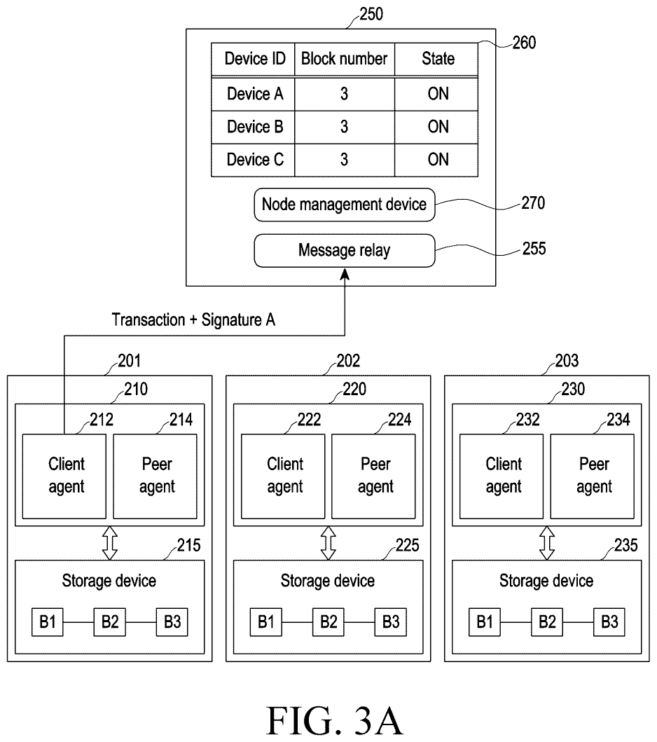

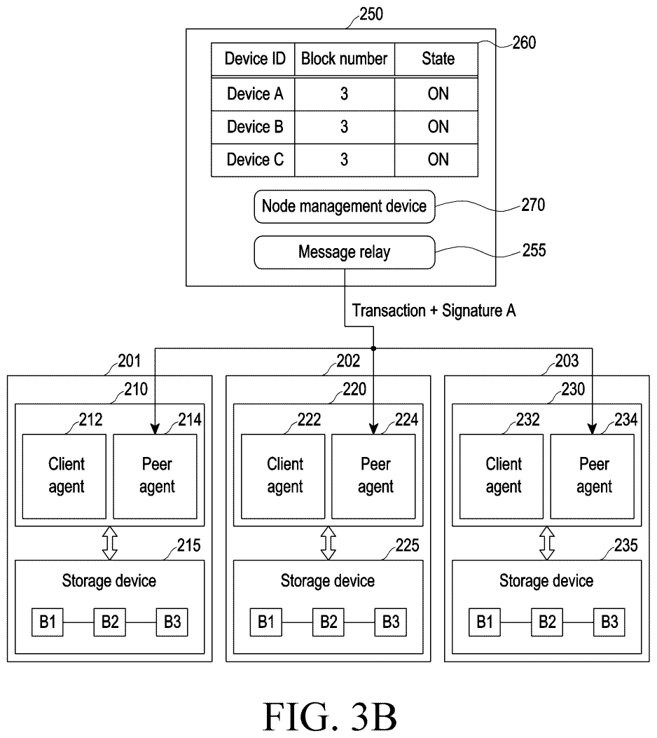

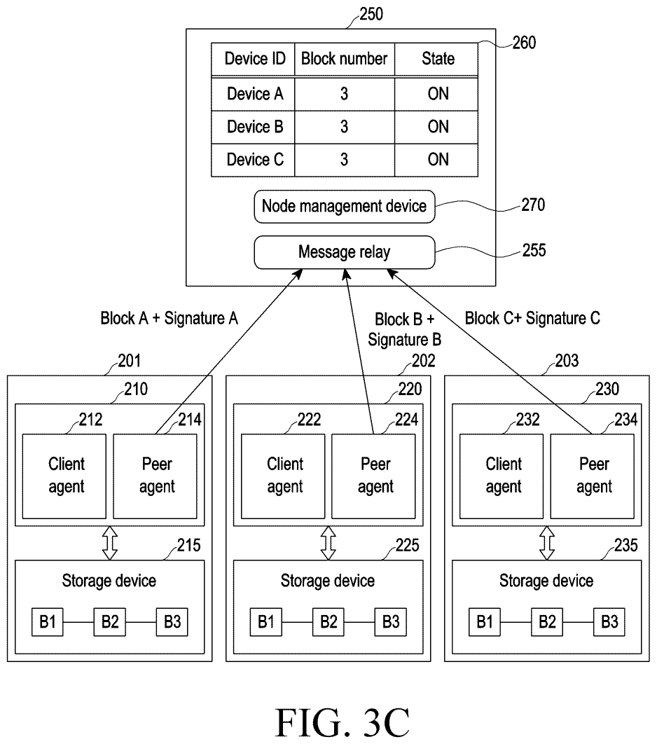

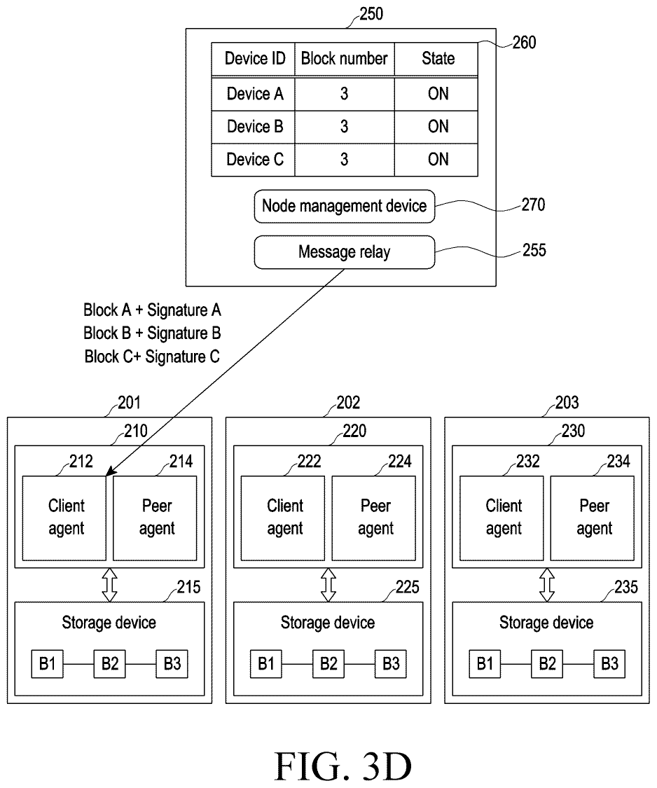

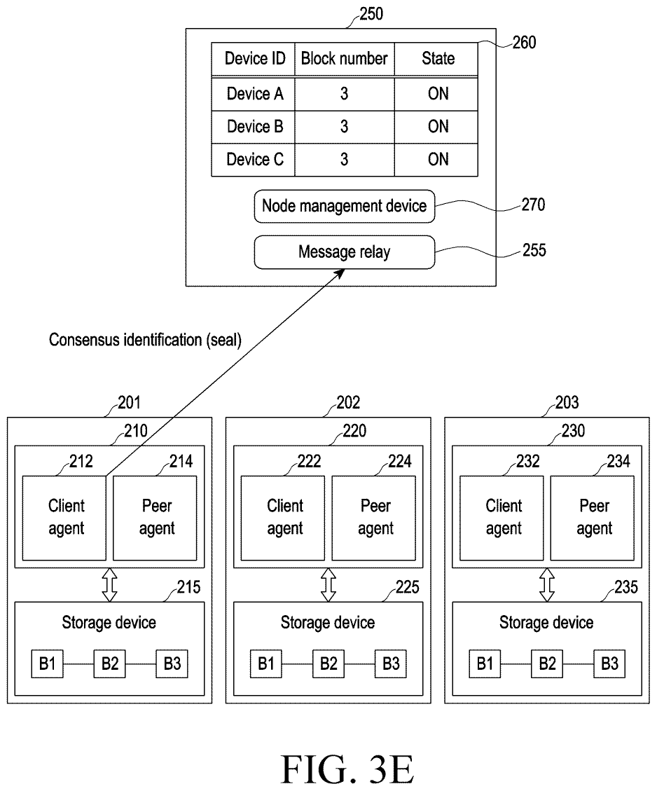

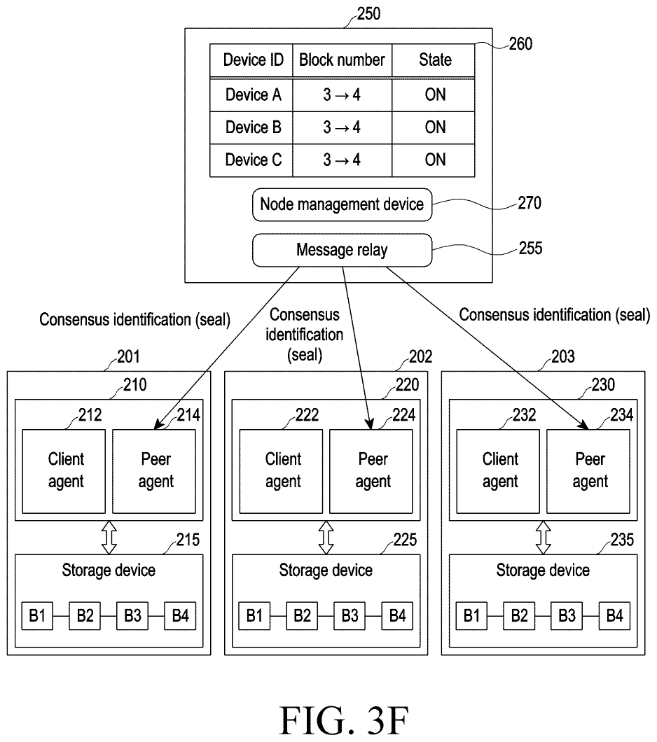

FIGS. 3A-3F are diagrams illustrating a method for adding a new block by an electronic device included in a blockchain network according to an embodiment.

Referring to FIG. 3A, according to an embodiment, the first electronic device 201 may access the server 250 (e.g., the server 108 in FIG. 1 or the server 250 in FIG. 2A) and identify information on a block lastly stored by each of nodes included in a blockchain network (e.g., the blockchain network 240 in FIG. 2A).

According to an embodiment, the first electronic device 201 may request, through the client agent 212, the server 250 (e.g., the message relay 255) to perform an operation for adding a new block to the nodes 201, 202, and 203 included in the blockchain network 240. For example, the server 250 may provide a mutex function. For example, the mutex function may include a function of providing a priority related to an operation of adding a new block to a node that has transmitted a request first.

According to an embodiment, when a request to add a new block is not rejected by the server 250, the first electronic device 201 may transmit, to the server 250 through the client agent 212, transaction information to be stored in the new block and first signature information (signature A) of the first electronic device 201 so that the server 250 transmits the transaction information and the first signature information (signature A) to the other nodes 202 and 203 included in the blockchain network 240. For example, the first signature information (signature A) may include unique information enabling identification of the first electronic device 201.

Referring to FIG. 3B, according to an embodiment, the server 250 may transmit the transaction information and the first signature information (signature A) to the nodes 201, 202, and 203 (e.g., the peer agents 214, 224, and 234) included in the blockchain network 240 through the message relay 255. According to implementation, the server 250 may also transmit the transaction information and the first signature information (signature A) to the nodes 202 and 203 other than the first electronic device 201.

Referring to FIG. 3C, according to an embodiment, each of the nodes 201, 202, and 203 may generate a new block in response to receiving, obtaining, or identifying the transaction information and the first signature information (signature A). For example, the first electronic device 201 may generate block A including the transaction information, the second electronic device 202 may generate block B including the transaction information, and the third electronic device 203 may generate block C including the transaction information.

According to an embodiment, each of the nodes 201, 202, and 203 may transmit the generated block (block A, block B, or block C) and signature information thereof (signature A, signature B, or signature C) to the server 250 (e.g., the message relay 255) through the peer agent 214, 224, or 234.

Referring to FIG. 3D, according to an embodiment, the first electronic device 201 may receive information (block B and block C) on the blocks generated by the other nodes 202 and 203 and the signature information thereof (signature B and signature C) from the server 250.

According to an embodiment, the first electronic device 201 may identify, through the client agent 212, a consensus related to addition of a new block (block A), based on the blocks (block B and block C) generated by the other nodes 202 and 203 and the signature information (signature B and signature C) of the other nodes 202 and 203. For example, the first electronic device 201 may identify the signature information (signature B and signature C) of the other nodes 202 and 203. In addition, when it is identified that the number of blocks, among the blocks (block B and block C) generated by the other nodes 202 and 203, which are identical to the block (block A) generated by the first electronic device 201, is greater than a specified number, the first electronic device 201 may determine that a consensus on adding a new block to each of the nodes 201, 202, or 203 has been completed. In addition, when it is identified that the number of blocks, among the blocks (block B and block C) generated by the other nodes 202 and 203, which are identical to the block (block A) generated by the first electronic device 201, is greater than a specified number, the first electronic device 201 may decide or determine the new block to be added to each of the nodes 201, 202, or 203 as “block A.”

Referring to FIG. 3E, according to an embodiment, when it is determined, through the client agent 212, that a consensus on adding a new block has been completed, the first electronic device 201 may transmit information (or consensus identification information) (e.g., seal) indicating the consensus to the server 250 (or the message relay 255) so that the server 250 transmits the information indicating the consensus to the other nodes 202 and 203. For example, the first electronic device 201 may obtain or generate the information indicating the consensus by using the signature information (signature A, signature B, or signature C) of each of the nodes 201, 202, and 203.

Referring to FIG. 3F, according to an embodiment, the server 250 may transmit the information (or consensus identification information or a seal) indicating the consensus to the nodes 201, 202, and 203 (e.g., the peer agents 214, 224, and 234) through the message relay 255.

According to an embodiment, the nodes 201, 202, and 203 may add and store a new block (″B4) in the storage devices 215, 225, or 235 of the nodes 201, 202, and 203 in response to receiving or identifying the information indicating the consensus, respectively.

According to an embodiment, the server 250 may update information on a block number in the table 260. For example, the server 250 may change the block number of each of the nodes included in the table 260 from “3” to “4.”

According to the operations of FIG. 3A to FIG. 3F described above, the nodes 201, 202, and 203 included in the blockchain network 240 may efficiently add a new block.

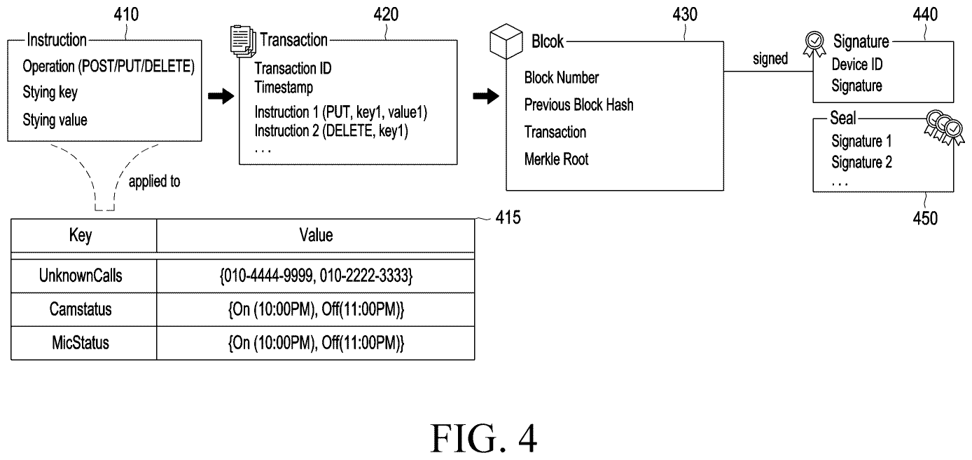

FIG. 4 is a diagram illustrating information related to a block according to an embodiment.

Referring to FIG. 4, according to an embodiment, transaction information 420 may be included or stored in a block 430.

According to an embodiment, the transaction information 420 may include a transaction ID, a time stamp, and at least one instruction. The transaction ID may include information for identifying a corresponding transaction. The time stamp may include information on a time at which the transaction has occurred. An instruction 410 may include a command (e.g., instruction 1 (PUT, key1, value1)) for performing a particular operation for a particular value included in a data table 415. For example, the instruction 410 may include a key, a value corresponding to the key, and a command for performing a particular operation (e.g., post, put, or delete) for the key and the value. For example, the key may indicate a particular key included in the data table 415, and the value may indicate a value indicated by a particular key included in the data table 415.

According to an embodiment, the block 430 may store information on the corresponding block. For example, the information on the block may include a block number, the transaction information 420, previous hash information (a previous block hash), and information on a merkle root. The block number may include information for identifying a corresponding block. The previous hash information may include hash information having been used in a previously generated block. The information on the merkleroot may include a final hash value derived from a data structure expressed in a tree form by summarizing all transaction information included in the block 430. For example, the previous hash information and the information on the merkle root may be used to verify or identify the integrity of the block 430.

According to an embodiment, a signature 440 may be used for a consensus for newly adding the block 430. For example, the signature 440 may include identification information of each of the nodes 201, 202, and 203 included in the blockchain network 240 and unique information (signature data) thereof.

According to an embodiment, a node (e.g., the first electronic device 201) having requested addition of a new block may, when it is identified that a consensus on adding a new block has been completed, generate information 450 (or consensus identification information) (e.g., seal) indicating the consensus. For example, the information 450 (or consensus identification information) indicating the consensus may be generated using the signatures of nodes having agreed. For example, the information 450 indicating the consensus may include the signatures or information obtained by hashing the signatures. The nodes 201, 202, and 203 included in the blockchain network 240 may, when the information 450 indicating the consensus is received and/or identified, add and store the corresponding block 430 in storage devices (e.g., the storage devices 215, 225, and 235 in FIG. 2).

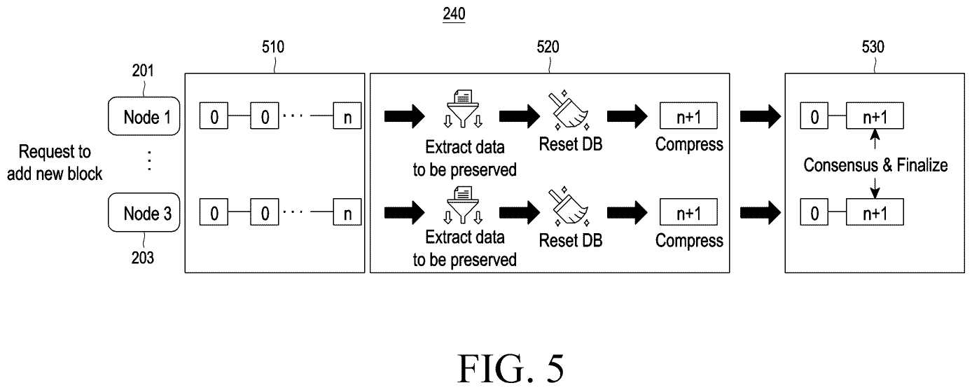

FIG. 5 is a diagram illustrating an example for performing, by an electronic device included in a blockchain network, data cleanup for blocks accumulated in memory when a new block exceeding a block capacity is added according to an embodiment.

Referring to FIG. 5, the nodes 201, 202, and 203 (e.g., multiple electronic devices) included in the blockchain network 240 according to an embodiment may, every time a consensus occurs, accumulate a block (e.g., data for blockchain) including information on the block (e.g., as information related to a block state, a key and/or a value corresponding to the key) and store (e.g., add) accumulated blocks in a database of memory (510). The nodes 201, 202, and 203 are unable to store data infinitely in an environment where a storage space is insufficient, and thus may designate a limited range (e.g., 0−n) by using block numbers to limit a block capacity (n) relating to stored data for a blockchain. The size of data for the blockchain may be proportional to a consensus count. The consensus count may be equal or proportional to the number of blocks.

The nodes according to an embodiment are state machines required to perform consensus identically. If individual initialization occurs, the consensus may become inconsistent. Therefore, the nodes may identically perform data initialization and maintain the same state even after the consensus. The nodes according to an embodiment may, when being identically to add a new block (n+1) exceeding a block capacity (n), perform a consensus operation 520 for cleaning up data about a block and perform an operation 530 for a consensus to add the new block. Each of the nodes, according to an embodiment, does not initialize (e.g., reset or remove) all blocks accumulated in the storage device, and may remove only a block for history and additional accumulated data while maintaining (e.g., preserving) data about a predetermined number of blocks.

According to an embodiment, the node 201 (a description will be given using, as an example, the electronic device 201) of a client requesting addition of a new block among the nodes may accumulate and store, in the memory, blocks (e.g., data about the blocks), in a specified limited range (e.g., 0−n), based on a block capacity (n) (510). When the block capacity is exceeded (e.g., when a block of block number n+1 is added), the node 201 may transmit, to the server 250, information related to a consensus 520 (compress) for data extraction and data cleanup (e.g., data initialization, data removal, or database reset) for initialization of the blocks pre-stored in the memory. Actual data cleanup in the nodes 201, 202, and 203 may be performed when a consensus to add a new block (e.g., block number n+1) exceeding the block capacity (n) is determined (e.g., the consensus is successful) or synchronization is performed (530). The other nodes 202 and 203 (e.g., the other electronic devices 202 and 203) may read or refer to a table (e.g., dashboard) for a state map of the server 250 and, when a new block is added, perform data cleanup to remove or initialize some blocks accumulated in the memory, receive, obtain, or identify new transaction information included in the new block (e.g., block number n+1) through the server 250, and add or store the new transaction information. Here, the data cleanup may be periodically performed every time the number of blocks accumulated in the memory exceeds the block capacity. Here, the block capacity (n) may represent a unit of the maximum block number that determines the total amount of preserved data. A transaction capacity (t) may indicate a maximum number of transactions that are able to be included in one block.

When data about at least one block to be preserved among the blocks accumulated in the memory is extracted, the electronic device 201, according to an embodiment, may identify a priority (e.g., a latest priority of the value) and extract data (e.g., transaction information (e.g., a key and/or a value corresponding to the key)) about at least one block corresponding to a transaction capacity according to the same pre-agreed policy. The electronic device 201, according to an embodiment, may determine data to be preserved by compressing the extracted data of the at least one block. The data to be preserved may be used for consensus determination or synchronization identically to a general block. The electronic device 201 may generate a command set (e.g., set) capable of reproducing a final state of the data to be preserved again by using an initial additional command (POST). The electronic device 201 may generate a block in which a command set is compressed as the new block (n+1) to be agreed and, at the time of consensus determination and synchronization, perform data cleanup (e.g., data initialization). The electronic device 201 may then reflect data about the compressed block to reproduce transaction information (e.g., a key and/or a value corresponding to the key) on the data to be preserved without change.

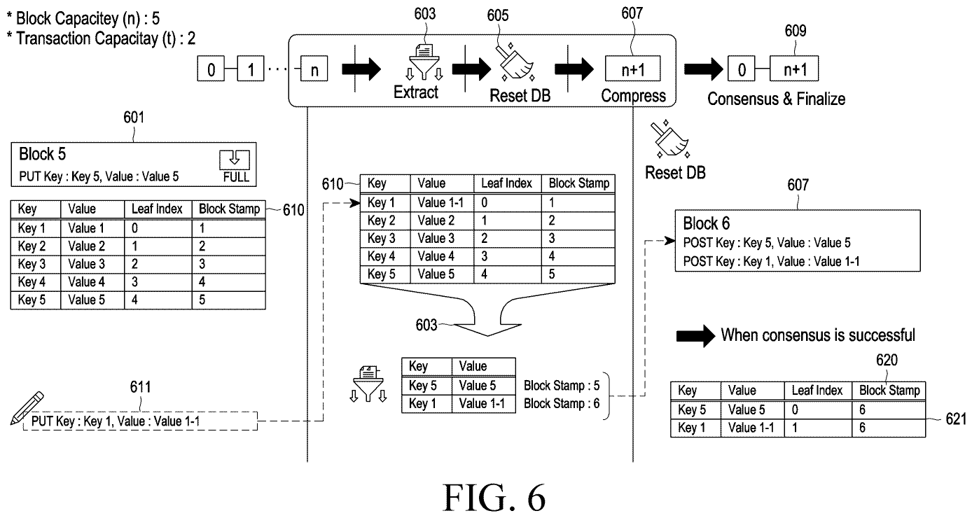

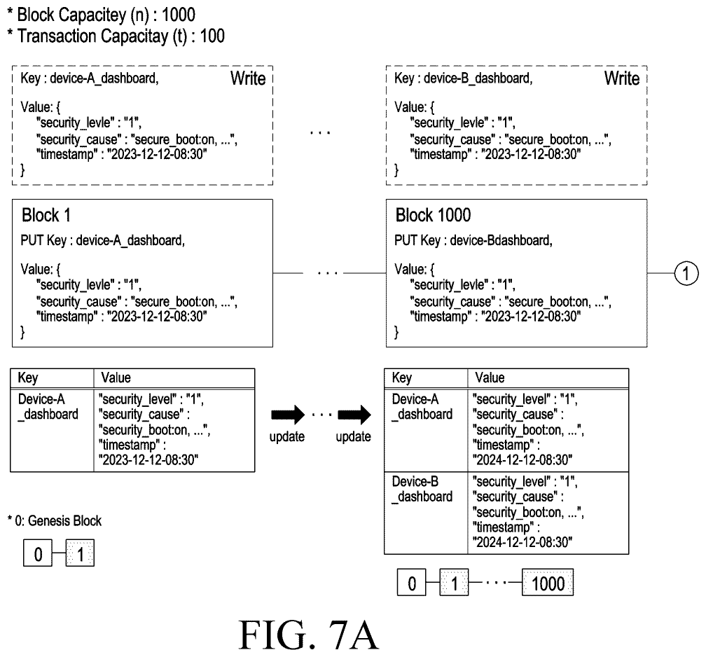

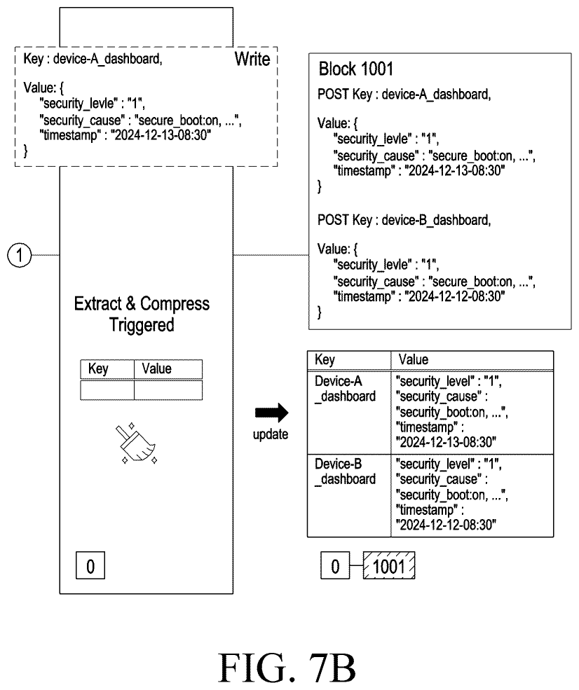

FIG. 6 is a diagram illustrating an example for performing, by an electronic device included in a blockchain network, data cleanup for blocks accumulated in memory when a new block exceeding a block capacity is added according to an embodiment. FIG. 7A and FIG. 7B are diagrams illustrating an example of a table for a stored state map of a server included in a blockchain network according to an embodiment. In the description for FIG. 6, a detailed operation for a data extraction and cleanup consensus operation of each node is described referring to a block capacity (n) (e.g., limited range) being 5, and a transaction capacity (t) being 2.

Referring to FIG. 6, according to an embodiment, the electronic device 201 may, when a block capacity (n) is in a full state 601 (e.g., block 5, PUT, Key: key 5, value: value 5), identify that a data cleanup consensus is needed. The electronic device 201 may, according to identifying that data cleanup is needed, when adding a new block (n+1) (e.g., block 6), perform data extraction 603 and data removal (erasing) 605 as data cleanup (e.g., data initialization, data removal, or database reset (reset DB)). The electronic device 201 may write (e.g., generate or determine) transaction information 611 (new transaction) (e.g., the transaction information 420 in FIG. 4) of the new block (605), and transmit the transaction information 611 of a new block generated through the peer agent 214 and signature information (e.g., signature A) of the electronic device to the server 250 (e.g., the message relay 255).

The server 250 may update a table 610 (e.g., dashboard) for a state map reflecting up to the transaction information 611. Here, the transaction information 611 may include a first command (PUT) (e.g., PUT key: key 1, value: value 1-1) included in an instruction. The electronic device 201 may, according to the block number (e.g., 6) of the new block exceeding the block capacity (e.g., 5), extract data (e.g., key 5, value 5 and key 1, value 1-1) about last (e.g., recently stored) two blocks (e.g., block numbers 5 and 6) based on block numbers, preserve only the extracted data, and remove (e.g., perform database reset) stored data. Here, the block number (block stamp) may be removed after being used only for arrangement, and the leaf index may also be removed because a merkle tree needs to be newly configured. Actual data removal related to the database reset may be performed in a finalization stage after the cleanup consensus is determined.

According to an embodiment, the electronic device 201 may generate (e.g., write or determine) and compress new transaction information 621 (e.g., POST key 5, value 5 and POST key 1, value 1-1), based on the data (e.g., key 5, value 5 and key 1, value 1-1) about the last (e.g., recently stored) two blocks (e.g., block numbers 5 and 6) to generate the new block (n+1) (e.g., block 6) (607) and, according to the new block (n+1) exceeding the block capacity (n), request a consensus for data cleanup to the server. Here, the new block may be a multi-transaction block because when a number corresponding to the transaction capacity is equal to or greater than 2, transaction information on recently accumulated two or more blocks may be extracted as data to be preserved. Here, the multi-transaction block employs a method of newly writing each extraction state by using POST OP operation and may enable simultaneous reproduction of multiple states during consensus and synchronization.

According to an embodiment, the electronic device 201 may transmit, to the server 250, the new transaction information 621 and signature information (e.g., signature A) included in information on the new block (n+1). The server 250 may, when a consensus for adding the new block (n+1) is successful 609, reset (e.g., perform metadata reset and refresh) a table 610 (e.g., dashboard) for a state map, and reflect the new transaction information 621 (e.g., key 5, value 5, leaf index 0, block stamp 6 and key 1, value 1-1, leaf index 1, block stamp 6) on the new block (n+1) on the reset table 620 (dashboard) for a state map. Here, the leaf index included in the table 620 (dashboard) for a state map be automatically updated (e.g., leaf index 0 and leaf index 1) after a merkle tree is newly generated. The block number (block stamp) included in the state table may reflect the new block (e.g., block 6) and may be automatically updated.

Each of the nodes 201, 202, and 203 according to an embodiment may transmit, to the server 250, data about a block and a command about blockchain data so that the server adds (e.g., writes, stores, or accumulates) the data about the block and writes (e.g., registers) the command about the blockchain data in the table 610 (e.g., a dashboard 710 in FIG. 7A and FIG. 7B) for a state map up to a specified block capacity (n) (e.g., 1000). The table 610 for a state map may distinguish between the nodes 201, 202, and 203 to write commands (e.g., data about a block) and be updated up to the specified block capacity (n) (e.g., 1000). When each of the nodes 201, 202, and 203 requests addition of a next new block (e.g., block number 1001) exceeding the specified block capacity (n) (e.g., 1000), the table 610 (e.g., the dashboard 710 in FIG. 7A and FIG. 7B) for a state map may be cleaned up (e.g., removed, initialized, or reset) and, when a consensus is successful, new transaction information on the next new block (e.g., block number 1001) may be reflected for each of the nodes 201, 202, and 203.

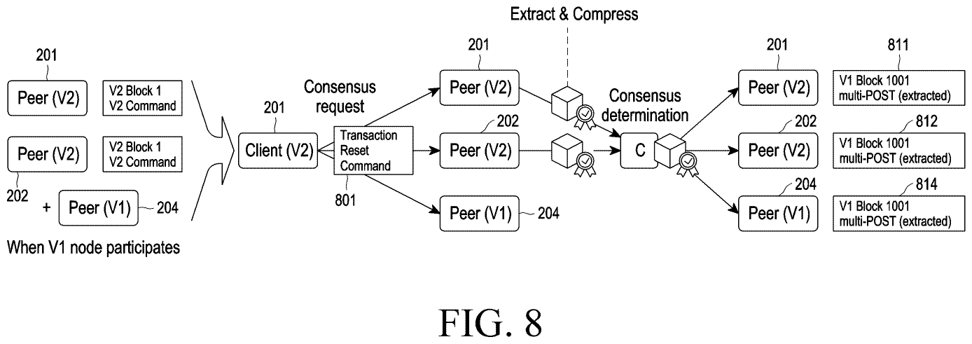

FIG. 8 is a diagram illustrating an example for performing, by an electronic device included in a blockchain network, data cleanup for higher-version blocks accumulated in memory when a lower-version node is added according to an embodiment. Hereinafter, for convenience of explanation, electronic devices 201, 202, and 204 corresponding to nodes included in the blockchain network 240 will be described as the nodes 201, 202, and 204 included in the blockchain network 140.

Referring to FIG. 2A, FIG. 2B, and FIG. 8, according to an embodiment, the electronic device 201 may access a server (e.g., the server 250 in FIG. 2A) configured to relay message transmissions between electronic devices (e.g., the multiple electronic devices 201 and 202 in FIG. 2A) corresponding to nodes 201 and 202 included in a blockchain network (e.g., the blockchain network 240 in FIG. 2A), and identify information on a block lastly stored by each of the nodes 201 and 202. For example, the server 250 may provide, to each of the nodes 201 and 202, information on the latest block of each of the nodes 201 and 202 included in the blockchain network 240. For example, the information on the latest block may include information on a block lastly stored by each of the nodes 201 and 202 included in the blockchain network 140.

According to an embodiment, the electronic device 201 corresponding to a first node is a client and may request the server 250 to add a new block (+1 block) to the other nodes 202, based on the identified information on the block. For example, the block number of the block lastly stored by each of the nodes 202 and 203 may not match the last number of a specified range (e.g., 1-1000).

According to an embodiment, when it is identified that synchronization for adding a new block has failed, the electronic device 201 may identify that a compatibility problem has occurred due to the inability to synchronize through the server 250. The electronic device 201 may identify the information on the block (e.g., information on the latest block) identified by reading or referring to a table (e.g., the table 610 for a map in FIG. 6 or the dashboard 710 in FIG. 7A and FIG. 7B) for a state map through the server 250, to identify that the lower-version new node 204 has been added to the blockchain network 240. According to an embodiment, when the information on the latest block is identified through the server 250 in order to add a new block before failure of a consensus is identified, the electronic device 201 may read or refer to a table (e.g., the table 610 for a map in FIG. 6 or the dashboard 710 in FIG. 7A and FIG. 7B) for a state map of the server 250, to identify that the new node 204 has been added.

According to an embodiment, the electronic device 201 may identify version information of the added new node 204 through the server 250. When it is identified that the new node 204 is a version (V1) (e.g., old version) lower than those of the other nodes 201, 202, and 203 included in the blockchain network 240, the electronic device 201 may identify that a compatibility problem has occurred and thus synchronization may be impossible. The other nodes 201, 202, and 203 may be devices of a higher version (V2) (e.g., new version). When synchronization is to be performed between nodes having different version information, due to the inability to synchronize, the inability to continue consensus may occur, resulting in a compatibility problem. Here, the synchronization may indicate a manner in which each node actually performs an instruction in a block received from the server 250 to reproduce a key/value. When a node of a lower version (V1) performs an instruction of a higher version (V2), the node is unable to understand and process the instruction, and thus an error may occur. A node having failed in synchronization is also unable to participate in a consensus. Therefore, the node of a lower version is continuously unable to participate in a consensus and thus a compatibility problem may occur. The electronic device 201 may, in order to solve a compatibility problem, perform a data cleanup consensus in response to a request when a node of a lower version (V1) is added.

According to an embodiment, the electronic device 201 may, based on identifying that the version information of the new node 204 is a lower version (V1), transmit, to the server 250, information related to a consensus to perform synchronization based on the lower version (V1). Here, the information related to the consensus may include a command (e.g., reset command) that requests a data extraction and cleanup consensus. The server 250 may provide information 801 related to a consensus to the other nodes 201 and 202 so that the other nodes perform synchronization and consensus through a command (reset command) that requests a data extraction and cleanup consensus in the lower version (V1). The new node 204 is unable to process the command (reset command) included in the information related to the consensus, and thus may be synchronized with the other nodes 201, 202, and 203 and store a new block 814 of the lower version in the memory. Each of the first node 201 and the second node 202 other than the new node 204 is able to process the command (reset command) included in the information related to the consensus, and thus may remove or erase all blocks of the higher version (V2) stored in the memory and add (e.g., store) a new block 811 or 812 of the lower version in the memory. The new block 811, 812, or 814 (e.g., V1 block) of the lower version may include a key, transaction information (e.g., multi-POST(extracted)) including a command of the lower version (V1) including a value for the key, a newly assigned block number (e.g., 1001), and a leaf index of a newly generated merkle tree. The transaction information including the command of the lower version (V1) may be generated by using an instruction (e.g., POST) that is understandable or processible in all versions. The newly assigned block number may be newly assigned starting from the start number (e.g., 1001) of a next range (e.g., 1001-2000) for the specified block capacity (n).

The above description of FIG. 8 has been separately given as an embodiment in which an electronic device included in a blockchain network performs a consensus to clean up data about blocks of a higher layer accumulated in the memory when a node of a lower version is added. However, the disclosure is not limited thereto, and when a new block exceeding a block capacity is added as in the embodiments described with reference to FIG. 5 and FIG. 6, a data cleanup consensus operation for blocks accumulated in the memory is performed and then the above embodiment may be performed within the next range.

According to an embodiment, the electronic device 201 may, based on identifying that the number of blocks accumulated in the memory is not the same as a specified block capacity, request the server 250 to add a new block to the nodes 201, 202, and 203. The electronic device 201 may, based on identifying, through the server 250, that the new node 204 has been added to the blockchain network 240, identify version information for synchronization between the nodes 201, 202, 203, and 204 included in the blockchain network 240 through the server 250. According to an embodiment, based on identifying that the version information of the new node 204 is a lower version (V1), the electronic device 201 may transmit, to the server 250, information related to a consensus to perform synchronization based on the lower version and, based on a consensus on adding a new block being successful, add (e.g., store) a new block of the lower version in the memory in a state where blocks of a higher version previously accumulated in the memory have been removed.

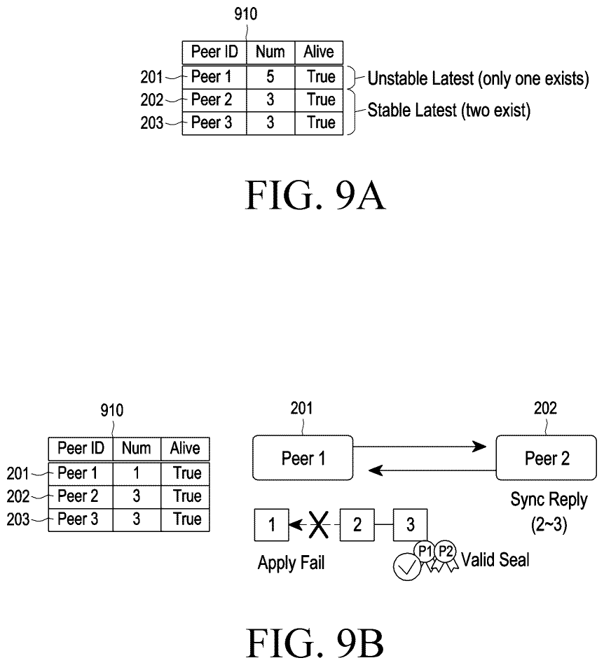

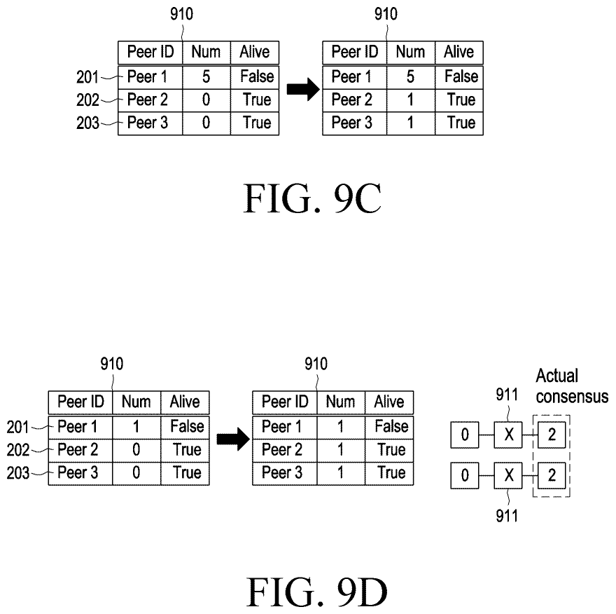

FIGS. 9A-9D9D are diagrams illustrating examples for operating a blockchain in an electronic device included in a blockchain network according to an embodiment. In the description of FIG. 9A-9D, an example for operating a blockchain to prevent a consensus from continuously failing due to a failure (e.g., being offline or inability to synchronize) of a node having the latest block number will be described in detail.

Referring to FIG. 2A, FIG. 2B, FIG. 9A, FIG. 9B, FIG. 9C, and FIG. 9D, the electronic device 201 according to an embodiment may read or identify, through communication circuitry, a table 910 of the server 250. The server 250 may be configured to relay message transmission between nodes (e.g., peer 1 201, peer 2 202, and peer 3 203) included in the blockchain network 240. The electronic device 201 may identify information on a block lastly stored in each of the nodes 201, 202, 203 and request synchronization and a consensus to add a new block.

According to an embodiment, when it is identified that a particular node (e.g., the first node 201) included in the blockchain network 240 has failed in synchronization with the nodes 202 and 203 due to a failure (e.g., being offline or inability to synchronize), the electronic device 201 may identify a stable number and an unstable number by identifying the block number of each of the nodes 201, 202, and 203 through the server 250. For example, the block number of the first node 201 may be an unstable number (unstable latest) (e.g., “5”), and the block number of the second node 202 and the third node 203 may be a stable number (stable latest) (e.g., “3”). Each of the nodes may perform retrieving, synchronization, and a consensus operation, based on only stable numbers (stable latest). For example, when f representing the number of stabilized numbers is 1, this may imply that another node having a stable number has left. For example, if valid blocks received from a node having a stable number are not locally connected, this may imply that the first node has been disregarded as a node having an unstable number. Here, f refers to a fault tolerance in a byzantine fault tolerance (BFT) model.

According to an embodiment, the electronic device 201 may disregard the unstable number, perform synchronization again to follow the stable number of the second node 202 and the third node 203, and perform a blockchain operation related to consensus. For example, when the electronic device 201 identifies an unstable number (e.g., “5”) as the block number of the first node thereof, the electronic device may disregard the block thereof, reset the block number (e.g., configure same to “1”) according to operation of the blockchain, and perform autonomous recovery using blocks (e.g., block 2 and block 3) to follow the stable number (e.g., “3”) of the second node 202 and the third node 203 to perform a synchronization operation again. The second node 202 and the third node 203 may disregard a block having the unstable number and perform a consensus. When the unstable number is disregarded, if the block number becomes identical (e.g., “1”), it may be impossible to distinguish between a stable number (stable latest) and an unstable number (unstable latest). The node (e.g., the first node 201) that has been disregarded as having an unstable number may have a hash chain different from that of a newly determined consensus and thus be unable to participate in future consensus. The node that has been disregarded as having an unstable number may perform a self-recovery operation to synchronize with other nodes to rejoin a next consensus so that the block number always represents a single chain.

According to an embodiment, the electronic device 201 may perform a next consensus based on a recovered stable number. The electronic device 201 may request, through the server 250, a consensus to add a new block to each of the nodes 201, 202, and 203, based on the stable number. The electronic device 201 may transmit information related to the consensus to the server 250.

According to an embodiment, if the consensus is successful, the electronic device 201 may add a new block in the memory. If the consensus is successful, the other nodes 202 and 203 may also add the new block in the memory.

According to an embodiment, when the block number during the next consensus matches an unstable number, the electronic device 201 may add a dummy block 911 corresponding to the unstable number and request a consensus by using the number (e.g., block number 2) next to the unstable number.

An operation for blockchain operation according to the above description of FIGS. 9A-9D has been given as a separate embodiment. However, the disclosure is not limited thereto, and when a new block exceeding a block capacity is added as in the embodiments described with reference to FIG. 5 and FIG. 6, a data cleanup consensus operation for blocks accumulated in the memory is performed and then the above embodiment may be performed within the next range.

An electronic device (e.g., the electronic device 101 in FIG. 1 and/or the electronic device 201 in FIG. 2A) according to an embodiment may implement a software module (e.g., the program 140 in FIG. 1) related to a blockchain. Memory (e.g., the memory 130 in FIG. 1 and/or the storage 215 in FIG. 2B) of the electronic device may store instructions to implement the software module. At least one processor (e.g., the processor 120 in FIG. 1 and/or the control device 210 in FIG. 2B) may execute the instructions stored in the memory to implement the software module and may control hardware (e.g., the communication module 190 in FIG. 1 or the display module 160 in FIG. 1) associated with a function of the software module.

The software module of the electronic device 101 or 201 according to an embodiment may be configured to include a kernel (or HAL), a framework (e.g., the middleware 144 in FIG. 1), and an application (e.g., the application 146 in FIG. 1). At least a part of the software module may be preloaded on the electronic device 101 or 201 or may be downloadable from a server (e.g., the server 108).

According to an embodiment, the kernel may include, for example, a system resource manager or a device driver, and may be configured to further include other modules without being limited thereto. The system resource manager may perform at least one of operation of control, allocation, or deallocation of system resources. The device driver may include, for example, a display driver, a camera driver, a Bluetooth driver, a shared memory driver, a USB driver, a keypad driver, a Wi-Fi driver, an audio driver, or an inter-process communication (IPC) driver.

According to an embodiment, the framework may provide a function commonly required by applications or may provide various functions to an application through an application programming interface (API) (not shown) so as to enable the application to efficiently use limited system resources inside the electronic device 101 or 201. The framework may include a module that forms a combination of various functions of elements. The framework may provide a specialized module for each type of an operating system in order to provide a differentiated function. The framework may dynamically remove some of the existing elements or add new elements.

According to an embodiment, the application may be configured to include an application (e.g., a module, manager, or program) related to a video streaming service. The application may include an application received from an external electronic device (e.g., the server 108, or the electronic device 102 in FIGS. 1, 104 in FIG. 1, the external electronic device 202, 203 in FIG. 2A, the server 250 in FIG. 2A). According to an embodiment, the application may include a preloaded application or a third party application downloadable from the server. Elements and element names of the software module according to the illustrated embodiment may vary depending on the type of the operating system. According to an embodiment, at least a part of the software module may be implemented using software, firmware, hardware, or a combination of at least two of them. At least a part of the software module may, for example, be implemented (e.g., executed) by a processor (e.g., an AP). At least a part of the software module may include, for example, a module, program, routine, set of instructions, or process for performing at least one function.

As described above, in an embodiment, main elements of the electronic device have been described with reference to the electronic device 101 or 201 illustrated in FIG. 1 and FIG. 2A. However, in various embodiments, not all the elements illustrated in FIG. 1 and FIG. 2A are essential elements, the electronic device 101 or 201 may be implemented by more elements than the illustrated elements, or the electronic device 101 or 201 may be implemented by fewer elements than the illustrated elements. In addition, the positions of main elements of the electronic device 101 or 201 described with reference to FIG. 1 and FIG. 2A may be changeable according to various embodiments.

According to an embodiment of the disclosure, an electronic device (e.g., the electronic device 101 in FIG. 1 or the electronic device 201 in FIG. 2A) corresponding to one of nodes included in a blockchain network may include communication circuitry (e.g., the communication module 190 in FIG. 1), at least one processor (e.g., the processor 120 in FIG. 1 or the control device 210 in FIG. 2B) including processing circuitry, and memory (e.g., the memory 130 in FIG. 1 or the storage device 215 in FIG. 2B) configured to store instructions.

According to an embodiment, the instructions may, when executed by the at least one processor individually or collectively, cause the electronic device to identify, through the communication circuitry, information on a block lastly stored in the nodes included in the blockchain network through a server configured to relay message transmission between the nodes, based on identifying that the number of blocks accumulated in the memory identified based on the identified information on the block is equal to a specified block capacity, request the server to add a new block in the nodes, extract, through the communication circuitry, transaction information on last blocks in a number corresponding to a specified transaction capacity from the nodes, generate new transaction information, based on the extracted transaction information, transmit, to the server, information related to a consensus to initialize blocks previously stored in the nodes, transmit the new transaction information to the server to allow the new transaction information, which is to be stored in the new block, to be transmitted to the nodes via the server, and based on a consensus on adding the new block being successful, add the new block to the memory in a state where previously accumulated blocks have been removed from the memory.

According to an embodiment, the new block may include a key, a newly assigned block number, an updated leaf index, and the transaction information including a value for the key.

According to an embodiment, the instructions may, when executed by the at least one processor individually or collectively, cause the electronic device to, in a case that the number corresponding to the transaction capacity is equal to or greater than 2, compress transaction information on two or more blocks lastly stored, to generate the new transaction information which is to be stored in the new block. According to an embodiment, a newly assigned block number may be identically reflected on the transaction information on the two or more blocks.

According to an embodiment, the instructions may, when executed by the at least one processor individually or collectively, cause the electronic device to, in case that blocks lastly stored in the nodes are identified as differing from each other, transmit, to the server, a message that requests a match of the blocks lastly stored in the nodes.

According to an embodiment, the instructions may, when executed by the at least one processor individually or collectively, cause the electronic device to, based on identifying that the number of blocks accumulated in the memory is not equal to a specified block capacity, request the server to add a new block in the nodes, based on identifying, through the server, that a new node has been added to the blockchain network, identify version information for synchronization between the nodes included in the blockchain network through the server, based on identifying that version information of the new node is a lower version, transmit information related to a consensus to perform synchronization based on the lower version to the server, and based on a consensus on adding the new block being successful, add the new block of the lower version to the memory in a state where previously accumulated blocks of a higher version have been removed from the memory.

According to an embodiment, the instructions may, when executed by the at least one processor individually or collectively, cause the electronic device to, based on identifying, based on the information on the block lastly stored, that a block number of the last block does not exceed a specified range and synchronization between the nodes has failed, identify a stable number and an unstable number, based on blocks of a second node having the stable number, recover a block of a first node having the unstable number to have a stable number during a next consensus and perform synchronization again, request, through the server, a consensus to add a new block to each of the nodes, based on the stable number, and based on the consensus being successful, add the new block to the memory.

According to an embodiment of the disclosure, an electronic device (e.g., the electronic device 101 in FIG. 1 or the electronic device 201 in FIG. 2A) corresponding to one of nodes included in a blockchain network may include communication circuitry (e.g., the communication module 190 in FIG. 1), at least one processor (e.g., the processor 120 in FIG. 1 or the control device 210 in FIG. 2A) including processing circuitry, and memory (e.g., the memory 130 in FIG. 1 or the storage device 215 in FIG. 2A) configured to store instructions.

According to an embodiment, the instructions may, when executed by the at least one processor individually or collectively, cause the electronic device to identify, through the communication circuitry information on a block lastly stored in the nodes included in the blockchain network through server configured to relay message transmission between the nodes, based on the identified information on the block, request the server to add a new block in the nodes, based on identifying, through the server, that a new node has been added to the blockchain network, identify version information for synchronization between the nodes included in the blockchain network through the server, based on identifying that version information of the new node is a lower version, transmit information related to a consensus to perform synchronization based on the lower version to the server, and based on a consensus on adding the new block being successful, add the new block of the lower version to the memory in a state where previously accumulated blocks of a higher version have been removed from the memory.

According to an embodiment, the new block of the lower version may include a key, a newly assigned block number, an updated leaf index, and transaction information including a command of the lower version including a value for the key.

According to an embodiment, the newly assigned block number may be newly assigned starting from a start number of a next range for a specified block capacity.

According to an embodiment, the instructions may, when executed by the at least one processor individually or collectively, cause the electronic device to generate the transaction information including the command of the lower version, and transmit the generated transaction information and signature information to the server through the communication circuitry.

According to an embodiment of the disclosure, an electronic device (e.g., the electronic device 101 in FIG. 1 or the electronic device 201 in FIG. 2A) corresponding to one of nodes included in a blockchain network may include communication circuitry (e.g., the communication module 190 in FIG. 1), at least one processor (e.g., the processor 120 in FIG. 1 or the control device 210 in FIG. 2A) including processing circuitry, and memory (e.g., the memory 130 in FIG. 1 or the storage device 215 in FIG. 2A) configured to store instructions.

According to an embodiment, the instructions may, when executed by the at least one processor individually or collectively, cause the electronic device to identify, through the communication circuitry, information on a block lastly stored in nodes included in the blockchain network through a server configured to relay message transmission between the nodes, based on synchronization between the nodes having failed, identify a stable number and an unstable number, based on blocks of a second node having the stable number, recover a block of a first node having the unstable number to have a stable number during a next consensus and perform synchronization again, request, through the server, a consensus to add a new block to each of the nodes, based on the stable number, and based on the consensus being successful, add the new block to the memory.

According to an embodiment, the instructions may, when executed by the at least one processor individually or collectively, cause the electronic device to, in case that a block number of the next consensus matches the unstable number, add a dummy block corresponding to the unstable number and request a consensus by using a number next to the unstable number.

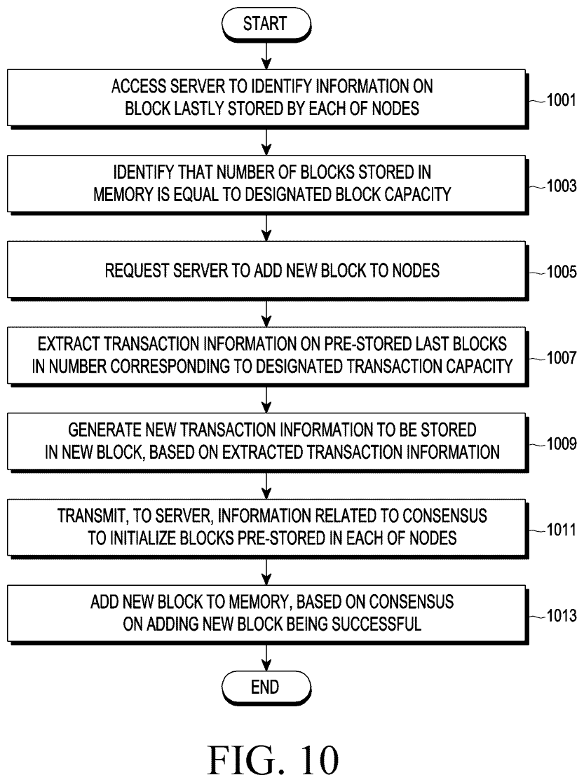

FIG. 10 is a flowchart illustrating a method for performing, by an electronic device included in a blockchain network, data cleanup for blocks accumulated in memory when a new block exceeding a block capacity is added according to an embodiment. In the embodiment below, operations may be sequentially performed, but sequential performance is not necessarily required. For example, the sequence of operations may be changed, and at least two operations may be performed in parallel.

Referring to FIG. 10, according to an embodiment, in operation 1001, an electronic device (e.g., the electronic device 101 in FIG. 1 or the electronic device 201 in FIG. 2A) may access a server (e.g., the server 250 in FIG. 2A) configured to relay message transmission between electronic devices (e.g., the multiple electronic devices 201, 202, and 203 in FIG. 2A) corresponding to nodes included in a blockchain network (e.g., the blockchain network 240 in FIG. 2A), and identify information on a block lastly stored by each of the electronic devices corresponding to the nodes. For example, the server 250 may provide information on the latest block of each of the electronic devices 201, 202, and 203 corresponding to the nodes included in the blockchain network 240, to the electronic devices 201, 202, and 203. For example, the information on the latest block may include information on a block lastly stored by each of the electronic devices corresponding to the nodes included in the blockchain network 240.

Hereinafter, for convenience of explanation, the electronic devices 201, 202, and 203 corresponding to nodes included in the blockchain network 240 will be described as the nodes included in the blockchain network 240.

According to an embodiment, in operation 1003, the electronic device 201 may identify, based on the information (e.g., block number) on a lastly stored block, that the blocks stored (e.g., accumulated) in the memory are in a full state up to a specified block capacity (n). The electronic device 201 may identify that the blocks stored in the memory are in a full state up to the block capacity by identifying whether the number of the blocks stored in the memory corresponds to the specified block capacity (n), based on the information (e.g., block number) on the lastly stored block. However, if the number of the stored blocks does not correspond to the specified block capacity, this corresponds to a state where the number of the accumulated blocks is smaller than the specified block capacity, and the electronic device may add a new block without data cleanup. In FIG. 10, for convenience of explanation, an operation method for adding a new block through data cleanup in a state where the blocks accumulated in the memory are in a full state up to the specified block capacity (n) is described, and a description of an operation for adding a new block when the specified block capacity is not reached is omitted. An operation method for adding a new block when the specified block capacity is not reached may be performed based on a method of performing a consensus to add a new block to the storage device of each of the nodes as described above with reference to FIG. 3A and FIG. 3F.

According to an embodiment, in operation 1005, the electronic device may identify that a data cleanup consensus (e.g., data initialization or removal) is needed, and may request the server to add a new block to the nodes included in the blockchain network. For example, the server may provide a mutex function. For example, the mutex function may include a function of providing a priority related to an operation of adding a new block to a node that has transmitted a request first. For example, the server may, when a priority related to an operation of adding a new block is assigned to a particular node, reject a request from another node while the particular node is adding the new block.

According to an embodiment, in operation 1007, when a request to add a new block is not rejected by the server, the electronic device may perform a consensus for data cleanup (e.g., data initialization, data removal, or database reset) for initializing (e.g., cleaning up or removing) the blocks accumulated in the memory in order to add (e.g., store) the new block. Actual data cleanup in the database of each of the nodes may be performed when the data cleanup consensus is determined (e.g., the consensus is successful). The electronic device may extract, as data to be preserved, data (e.g., transaction information) about the last blocks in a number corresponding to a specified transaction capacity before the data cleanup consensus.

According to an embodiment, in operation 1009, the electronic device may generate new transaction information, based on the extracted data (e.g., transaction information) so that the extracted data to be preserved is maintained (e.g., preserved).

According to an embodiment, in operation 1011, the electronic device may transmit, to the server, information related to a consensus (e.g., data cleanup consensus) to initialize (e.g., remove or clean up) the blocks pre-stored in the memory of each of the nodes. The transaction information of the new block generated (e.g., determined) before data cleanup may be written in a state map table of the server and, when the information related to a consensus for data cleanup (reset) is received from the electronic device, the server may clean up (e.g., remove, initialize, or reset) pieces of data written in the state map table.

According to an embodiment, in operation 1013, the electronic device may, based on a consensus on adding a new block being successful, add the new block to the memory in a state where the previously accumulated blocks have been removed from the memory (e.g., the storage device 215 in FIG. 2B and FIG. 3A to FIG. 3F).

According to an embodiment, the electronic device may receive, from the server, information on blocks generated by the nodes included in the blockchain network, based on transaction information. The electronic device may receive, from the server, information on a signature of each of the nodes together with the blocks generated by the nodes. According to an embodiment, the electronic device may identify whether there is a consensus related to addition of a new block, based on the information on the signature of each of the nodes and the blocks generated by the nodes included in the blockchain network. For example, when it is identified that the number of blocks identical to a new block generated by the electronic device among blocks generated by the other nodes included in the blockchain network is greater than a specified number, the electronic device may determine that a consensus to add a new block to each node has been completed. For example, the electronic device may compare previous hash information and information on a merkle root included in the new block generated by the electronic device, with previous hash information and information on a merkle root included in each of the blocks generated by the other nodes. When the previous hash information and the information on the merkle root included in the new block generated by the electronic device are identical to the previous hash information and the information on the merkle root included in each of the blocks generated by the other nodes, the electronic device may determine that the new block generated by the electronic device is identical to the blocks generated by the other nodes. According to an embodiment, the electronic device may transmit, to the server, information related to a consensus on adding a new block to store new transaction information. When it is identified that the number of blocks identical to the new block among the blocks generated by the other nodes included in the blockchain network is greater than a specified number, the electronic device may transmit information (e.g., seal) indicating a consensus to the server so that the server transmits the information indicating the consensus to the other nodes included in the blockchain network. For example, the information indicating the consensus may be obtained by using the information on the signature of each of the nodes 201, 202, and 203. The electronic device may, based on transmitting the information indicating the consensus to the server, add a new block in a state where previously accumulated blocks have been removed from the memory included in the electronic device. After the electronic device transmits the information indicating the consensus to the server, the server may transmit the information indicating the consensus to each of the other nodes. Thereafter, the new block may be added to a storage device (e.g., the storage device 225 or 235 in FIG. 2B and FIG. 3A to FIG. 3F) of each of the other nodes.

The electronic device according to an embodiment may perform data cleanup in each of the nodes according to the operation method of FIG. 10 described above, whereby data about the previously accumulated blocks are cleaned up (e.g., removed or initialized) in the storage device of each of the nodes and blocks may be accumulatively stored again within a limited range based on a block capacity. The electronic device may perform the operation method of FIG. 10 every time the accumulated blocks reach the block capacity. Here, the block numbers of the accumulated blocks may be configured to continue from the previous number even if data cleanup is performed, and if necessary (e.g., initialization of the blockchain network), may be initialized to 0 and configured to start again from 0.

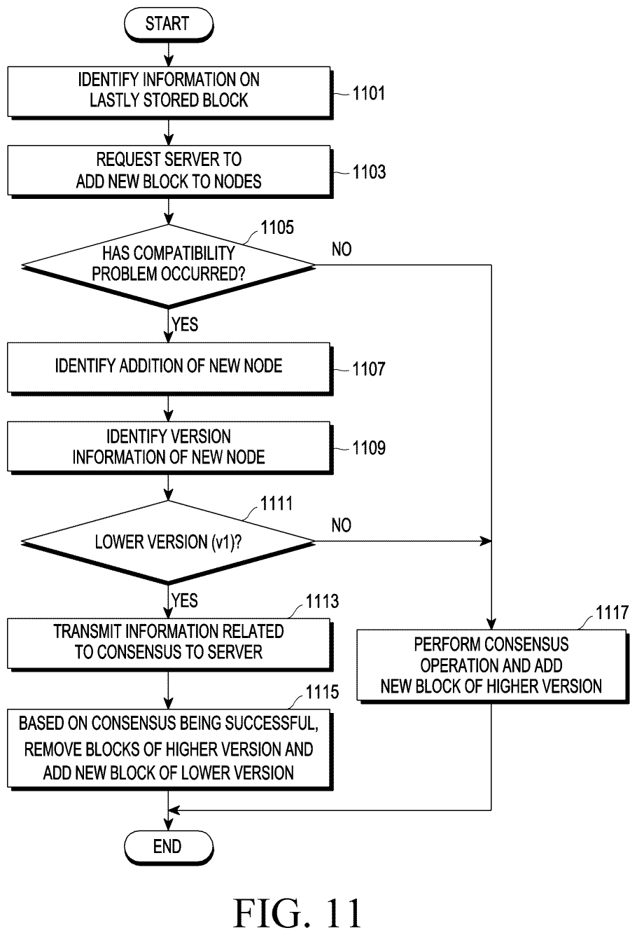

FIG. 11 is a flowchart illustrating a method for performing, by an electronic device included in a blockchain network, data cleanup for higher-version blocks accumulated in memory when a lower-version node is added according to an embodiment. In the embodiment below, operations may be sequentially performed, but sequential performance is not necessarily required. For example, the sequence of operations may be changed, and at least two operations may be performed in parallel.

Referring to FIG. 11, according to an embodiment, in operation 1101, an electronic device (e.g., the electronic device 101 in FIG. 1 or the electronic device 201 in FIG. 2A) may access a server (e.g., the server 250 in FIG. 2A) configured to relay message transmission between electronic devices (e.g., the multiple electronic devices 201, 202, and 203 in FIG. 2A) corresponding to nodes included in a blockchain network (e.g., the blockchain network 240 in FIG. 2A), and identify information on a block lastly stored by each of the electronic devices corresponding to the nodes. The server may provide information on the latest block of each of the nodes included in the blockchain network 240 to each of the nodes. Here, the information on the latest block may include information on a block lastly stored by each of the nodes included in the blockchain network.

In operation 1103, the electronic device may request the server to add a new block to the nodes, based on the information (e.g., information on the latest block) on the lastly stored block.

In operation 1105, the electronic device may identify whether a compatibility problem has occurred. If a result of the identification indicates that synchronization has failed and thus a compatibility problem has occurred, the electronic device may perform operation 1107 and, otherwise, perform operation 1117.

In operation 1107, the electronic device may read or identify a table of the server to identify that a new node (e.g., the new node 204 in FIG. 8) has been added to the blockchain network, based on the information (e.g., the information on the latest block and/or signature information) on the lastly stored block. Thereafter, after the operation is terminated, when a consensus is requested or a new node is added again, the electronic device may perform the operation method of FIG. 11.

In operation 1109, the electronic device may identify, through the server, version information for synchronization between the nodes included in the blockchain network.

In operation 1111, the electronic device may identify whether the version information of the new node is a lower version. If a result of the identification indicates a lower version, the electronic device may perform operation 1113 and, if the result indicates a higher version, the electronic device may, in operation 1117, perform a consensus operation for adding a block of the higher version and add a block of the higher version to the memory.

In operation 1113, when the new node is identified as being a lower version, the electronic device may transmit, to the server, information related to a consensus to perform synchronization based on the lower version.

In operation 1115, the electronic device may, based on a consensus on adding a new block being successful, remove higher-version blocks previously accumulated in the memory, and add (e.g., store) a lower-version new block to the memory. The new block of the lower version may include a key, a newly assigned block number, a leaf index of a newly generated merkle tree, and transaction information including a command of the lower version including a value for the key. The newly assigned block number may be newly assigned starting from the start number of a next range for a specified block capacity.

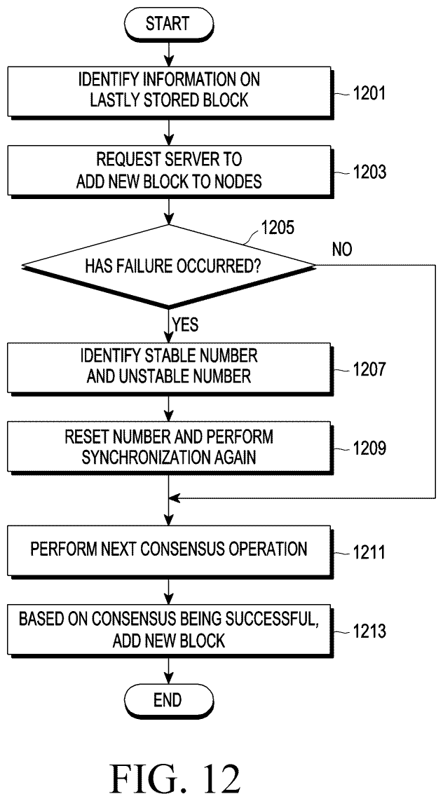

FIG. 12 is a flowchart illustrating a method for operating a blockchain in an electronic device included in a blockchain network according to an embodiment. In the embodiment below, operations may be sequentially performed, but sequential performance is not necessarily required. For example, the sequence of operations may be changed, and at least two operations may be performed in parallel.

Referring to FIG. 12, according to an embodiment, in operation 1201, an electronic device (e.g., the electronic device 101 in FIG. 1 or the electronic device 201 in FIG. 2A) may access a server (e.g., the server 250 in FIG. 2A) configured to relay message transmission between electronic devices (e.g., the multiple electronic devices 201, 202, and 203 in FIG. 2A) corresponding to nodes included in a blockchain network (e.g., the blockchain network 240 in FIG. 2A), and identify information on a block lastly stored by each of the electronic devices corresponding to the nodes. The server may provide information on the latest block of each of the nodes included in the blockchain network 240 to each of the nodes. Here, the information on the latest block may include information on a block lastly stored by each of the nodes included in the blockchain network.

In operation 1203, the electronic device may request the server to add a new block to the nodes, based on the information (e.g., information on the latest block) on the lastly stored block.

In operation 1205, the electronic device may identify whether a failure (e.g., being offline or inability to synchronize) has occurred in a particular node (e.g., the first node 201) included in the blockchain network 240. If a result of the identification indicates that a failure has occurred, the electronic device may perform operation 1207 and, otherwise, perform operation 1211.

In operation 1207, the electronic device may identify a stable number and an unstable number by identifying the block number of each of the nodes through a state map table of the server. For example, as illustrated in FIG. 9A to FIG. 9D, the block number of the first node 201 may be an unstable number (unstable latest) (e.g., “5”), and the block number of the second node 202 and the third node 203 may be a stable number (stable latest) (e.g., “3”). Each of the node may perform retrieving, synchronization, and a consensus operation, based on only stable numbers (stable latest). For example, when f representing the number of stabilized numbers is 1, this may imply that another node having a stable number has left. For example, if valid blocks received from a node having a stable number are not locally connected, this may imply that the first node has been disregarded as a node having an unstable number. Here, f refers to a fault tolerance in a byzantine fault tolerance (BFT) model.

In operation 1209, the electronic device may disregard the unstable number, perform synchronization again to follow the stable number of the nodes having the stable number (e.g., the second node 202 and the third node 203 as illustrated in FIG. 9B), and perform a consensus operation. For example, when the electronic device identifies an unstable number (e.g., “5”) as the block number of the first node thereof, the electronic device may disregard the block thereof, reset the block number (e.g., configure same to “1”) according to operation of the blockchain, and execute autonomously recovery by performing again a synchronization operation using blocks (e.g., block 2 and block 3) to follow the stable number (e.g., “3”) of the second node 202 and the third node 203. The second node 202 and the third node 203 may disregard a block having the unstable number and perform a consensus. When the unstable number is disregarded, if the block number becomes identical (e.g., “1”), it may be impossible to distinguish between a stable number (stable latest) and an unstable number (unstable latest). The node (e.g., the first node 201) that has been disregarded as having an unstable number may have a hash chain different from that of a newly determined consensus and thus be unable to participate in future consensus. The node that has been disregarded as having an unstable number may perform a self-recovery operation to synchronize with other nodes to rejoin a next consensus so that the block number always represents a single chain.

In operation 1211, the electronic device may perform a next consensus based on the stable number. The electronic device may request, through the server, a consensus to add a new block to each of the nodes, based on the stable number. The electronic device may transmit information related to the consensus to the server.

In operation 1213, the electronic device may add (e.g., store) a new block to the memory, based on the consensus being successful. If the consensus is successful, the other nodes may also add the new block in the memory.

According to an embodiment, when the block number during the next consensus matches an unstable number, the electronic device may add a dummy block corresponding to the unstable number and request a consensus by using the number (e.g., block number 2) next to the unstable number.

According to an embodiment, an operation method of an electronic device (e.g., the electronic device 101 in FIG. 1 or the electronic device 201 in FIG. 2A) corresponding to one of nodes included in a blockchain network may include identifying, through communication circuitry (e.g., the communication module 190 in FIG. 1) of the electronic device, information on a block lastly stored in the nodes included in the blockchain network through a server configured to relay message transmission between the nodes, based on identifying that the number of blocks accumulated in memory identified based on the identified information on the block is equal to a specified block capacity, requesting the server to add a new block in the nodes, extracting, through the communication circuitry, transaction information on last blocks in a number corresponding to a specified transaction capacity from the nodes, generating new transaction information, based on the extracted transaction information, transmitting, to the server, information related to a consensus to initialize blocks previously stored in the nodes, transmitting the new transaction information to the server to allow the new transaction information, which is to be stored in the new block, to be transmitted to the nodes via the server, and based on a consensus on adding the new block being successful, adding the new block to the memory in a state where previously accumulated blocks have been removed from the memory.

According to an embodiment, the new block may include a key, a newly assigned block number, an updated leaf index, and the transaction information including a value for the key.

According to an embodiment, the generating of the new transaction information may include, in a case that the number corresponding to the transaction capacity is equal to or greater than 2, compressing transaction information on two or more blocks lastly stored, to generate the new transaction information which is to be stored in the new block. According to an embodiment, a newly assigned block number may be identically reflected on the transaction information on the two or more blocks.

According to an embodiment, the method may further include, in case that blocks lastly stored in the nodes are identified as differing from each other, transmitting, to the server, a message that requests a match of the blocks lastly stored in the nodes.

According to an embodiment, the method may further include, based on identifying that the number of blocks accumulated in the memory is not equal to a specified block capacity, requesting the server to add a new block in the nodes, based on identifying, through the server, that a new node has been added to the blockchain network, identifying version information for synchronization between the nodes included in the blockchain network through the server, based on identifying that version information of the new node is a lower version, transmitting information related to a consensus to perform synchronization based on the lower version to the server, and based on a consensus on adding the new block being successful, adding the new block of the lower version to the memory in a state where previously accumulated blocks of a higher version have been removed from the memory.

According to an embodiment, the method may further include, based on identifying, based on the information on the block lastly stored, that a block number of the last block does not exceed a specified range and synchronization between the nodes has failed, identifying a stable number and an unstable number, based on blocks of a second node having the stable number, recovering a block of a first node having the unstable number to have a stable number during a next consensus and performing synchronization again, requesting, through the server, a consensus to add a new block to each of the nodes, based on the stable number, and based on the consensus being successful, adding the new block to the memory.

According to an embodiment, in a non-transitory storing medium storing one or more programs, the one or more programs may include instructions which, when executed by at least one processor of an electronic device, cause the electronic device to execute operations of identifying, through communication circuitry of the electronic device, information on a block lastly stored in the nodes included in the blockchain network through a server configured to relay message transmission between the nodes, based on identifying that the number of blocks accumulated in memory identified based on the identified information on the block is equal to a specified block capacity, requesting the server to add a new block in the nodes, extracting, through the communication circuitry, transaction information on last blocks in a number corresponding to a specified transaction capacity from the nodes, generating new transaction information, based on the extracted transaction information, transmitting, to the server, information related to a consensus to initialize blocks previously stored in the nodes, transmitting the new transaction information to the server to allow the new transaction information, which is to be stored in the new block, to be transmitted to the nodes via the server, and based on a consensus on adding the new block being successful, adding the new block to the memory in a state where previously accumulated blocks have been removed from the memory.

According to an embodiment, the one or more programs may include a instruction which, when executed by the at least one processor of the electronic device, cause the electronic device to execute an operation of, in a case that the number corresponding to the transaction capacity is equal to or greater than 2, compressing transaction information on two or more blocks lastly stored, to generate the new transaction information which is to be stored in the new block. According to an embodiment, a newly assigned block number may be identically reflected on the transaction information on the two or more blocks.

According to an embodiment, the one or more programs may include a instruction which, when executed by the at least one processor of the electronic device, cause the electronic device to execute an operation of, in case that blocks lastly stored in the nodes are identified as differing from each other, transmitting, to the server, a message that requests a match of the blocks lastly stored in the nodes.

According to an embodiment of the disclosure, an electronic device (e.g., a node) may resolve a problem in which, when the storage space of available memory in the system is lack and the storage space becomes full, storage of consensus data is no longer possible, resulting in an inability to continue consensus. The electronic device may guarantee the circularity of a blockchain to fundamentally prevent system errors and maximize efficiency without degrading usability. According to an embodiment of the disclosure, when a lower-version node is added, the electronic device may perform a cleanup consensus operation of removing or erasing (e.g., initializing) all high-version blocks of nodes through a cleanup consensus and add a new block in the lower version so as to perform a new consensus operation without compatibility problems. According to an embodiment of the disclosure, the electronic device may continue the consensus even when a failure occurs, such as being offline for a long period due to reasons, such as power/network, or being in a state where synchronization and continuous consensus are not possible. Various other effects identified directly or indirectly through the disclosure may be provided. Effects which are acquirable by the disclosure are not limited to the effects described above, and other effects that have not been mentioned may be clearly understood by a person who has common knowledge in the technical field to which the disclosure belongs, from the following description.

The embodiments disclosed herein are proposed for explanation and understanding of the disclosed technical content, and are not intended to limit the scope of the technology disclosed herein. Therefore, the scope of this document should be interpreted as including all variations or various other embodiments based on the technical concept of this document.

What is claimed is:

1. An electronic device corresponding to one node of nodes included in a blockchain network, the electronic device comprising:
communication circuitry;
at least one processor comprising processing circuitry; and
memory configured to store instructions,
wherein the instructions, when executed by the at least one processor individually or collectively, cause the electronic device to:
receive, using the communication circuitry, information on a block lastly stored in the nodes included in the blockchain network, wherein the information is transmitted by a server configured to relay message transmissions between the nodes;
identify a number of blocks accumulated in the memory based on the information;
based on the number of blocks being equal to a specified block capacity, request the server to add a new block in the nodes;
extract, using the communication circuitry, transaction information on last blocks in a number corresponding to a specified transaction capacity from the nodes;
generate new transaction information, based on the extracted transaction information;
transmit, to the server, information related to a consensus to initialize blocks previously stored in the nodes;
transmit the new transaction information to the server to allow the new transaction information, which is to be stored in the new block, to be transmitted to the nodes via the server; and
based on a consensus on adding the new block being successful, add the new block to the memory in a state where previously accumulated blocks have been removed from the memory.

2. The electronic device of claim 1, wherein the new block comprises a key, a newly assigned block number, an updated leaf index, and the transaction information including a value for the key.

3. The electronic device of claim 1, wherein the instructions, when executed by the at least one processor individually or collectively, cause the electronic device to:
based on the number corresponding to the transaction capacity being equal to or greater than 2, compress transaction information on two or more blocks lastly stored,
wherein the new transaction information is generated based on the compressed transaction information, and
wherein a newly assigned block number is identically reflected on the transaction information on the two or more blocks.

4. The electronic device of claim 1, wherein the instructions, when executed by the at least one processor individually or collectively, cause the electronic device to:
based on blocks lastly stored in the nodes being identified as differing from each other, transmit, to the server, a message requesting a match of the blocks lastly stored in the nodes.

5. The electronic device of claim 1, wherein the instructions, when executed by the at least one processor individually or collectively, cause the electronic device to:
based on the number of blocks being not equal to the specified block capacity, request the server to add a second new block in the nodes;
based on identifying, through the server, that a new node has been added to the blockchain network, identify version information for synchronization between the nodes included in the blockchain network through the server;
based on identifying that the version information of the new node is a lower version, transmit information related to a consensus to perform synchronization based on the lower version to the server; and
based on a second consensus on adding the second new block being successful, add the second new block of the lower version to the memory in a state where previously accumulated blocks of a higher version have been removed from the memory.

6. The electronic device of claim 1, wherein the instructions, when executed by the at least one processor individually or collectively, cause the electronic device to:
based on the information on the block lastly stored, identify that a block number of the last block does not exceed a specified range and synchronization between the nodes has failed;
based on identifying that the block number of the last block does not exceed the specified range and that the synchronization between the nodes has failed, identify a stable number and an unstable number;
based on blocks of a second node having the stable number, recover a block of a first node having the unstable number, the block of the first node to have a stable number during a next consensus and synchronization;
request, through the server, a consensus to add a second new block to each of the nodes, based on the stable number; and
based on the consensus to add the second new block to each of the nodes being successful, add the second new block to the memory.

7. An operation method of an electronic device corresponding to one node of nodes included in a blockchain network, the method comprising:
receiving, using communication circuitry of the electronic device, information on a block lastly stored in the nodes included in the blockchain network, wherein the information is transmitted by a server configured to relay message transmissions between the nodes;
identifying a number of blocks accumulated in the memory based on the information;
based on the number of blocks being equal to a specified block capacity, requesting the server to add a new block in the nodes;
extracting, using the communication circuitry, transaction information on last blocks in a number corresponding to a specified transaction capacity from the nodes;
generating new transaction information, based on the extracted transaction information;
transmitting, to the server, information related to a consensus to initialize blocks previously stored in the nodes;
transmitting the new transaction information to the server to allow the new transaction information, which is to be stored in the new block, to be transmitted to the nodes via the server; and
based on a consensus on adding the new block being successful, adding the new block to the memory in a state where previously accumulated blocks have been removed from the memory.

8. The method of claim 7, wherein the new block comprises a key, a newly assigned block number, an updated leaf index, and the transaction information including a value for the key.

9. The method of claim 7, wherein the generating of the new transaction information comprises:
based on the number corresponding to the transaction capacity being equal to or greater than 2, compressing transaction information on two or more blocks lastly stored,
wherein the new transaction information is generated based on the compressed transaction information, and
wherein a newly assigned block number is identically reflected on the transaction information on the two or more blocks.

10. The method of claim 7, further comprising:
based on blocks lastly stored in the nodes being identified as differing from each other, transmitting, to the server, a message requesting a match of the blocks lastly stored in the nodes.

11. The method of claim 7, further comprising:
based on the number of blocks being not equal to the specified block capacity, requesting the server to add second a new block in the nodes;
based on identifying, through the server, that a new node has been added to the blockchain network, identifying version information for synchronization between the nodes included in the blockchain network through the server;
based on identifying that the version information of the new node is a lower version, transmitting information related to a consensus to perform synchronization based on the lower version to the server; and
based on a second consensus on adding the second new block being successful, adding the second new block of the lower version to the memory in a state where previously accumulated blocks of a higher version have been removed from the memory.

12. The method of claim 7, further comprising:
based on the information on the block lastly stored, identifying that a block number of the last block does not exceed a specified range and synchronization between the nodes has failed;
based on identifying that the block number of the last block does not exceed the specified range and that the synchronization between the nodes has failed, identifying a stable number and an unstable number;
based on blocks of a second node having the stable number, recovering a block of a first node having the unstable number, the block of the first node to have a stable number during a next consensus and synchronization;
requesting, through the server, a consensus to add a second new block to each of the nodes, based on the stable number; and
based on the consensus to add the second new block to each of the nodes being successful, adding the second new block to the memory.

13. A non-transitory storing medium storing one or more programs, the programs comprising instructions which, when executed by at least one processor of an electronic device individually or collectively, cause the electronic device to execute operations of:
receiving, using communication circuitry of the electronic device, information on a block lastly stored in the nodes included in the blockchain network, wherein the information is transmitted by a server configured to relay message transmissions between the nodes;
identifying a number of blocks accumulated in the memory based on the information;
based on the number of blocks being equal to a specified block capacity, requesting the server to add a new block in the nodes;
extracting, using the communication circuitry, transaction information on last blocks in a number corresponding to a specified transaction capacity from the nodes;
generating new transaction information, based on the extracted transaction information;
transmitting, to the server, information related to a consensus to initialize blocks previously stored in the nodes;
transmitting the new transaction information to the server to allow the new transaction information, which is to be stored in the new block, to be transmitted to the nodes via the server; and
based on a consensus on adding the new block being successful, adding the new block to the memory in a state where previously accumulated blocks have been removed from the memory.

14. The non-transitory storing medium of claim 13, wherein the programs comprise an instruction which, when executed by the at least one processor of the electronic device, cause the electronic device to execute an operation of:
based on the number corresponding to the transaction capacity being equal to or greater than 2, compressing transaction information on two or more blocks lastly stored,
wherein the new transaction information is generated based on the compressed transaction information, and
wherein a newly assigned block number is identically reflected on the transaction information on the two or more blocks.

15. The non-transitory storing medium of claim 13, wherein the programs comprise an instruction which, when executed by the at least one processor of the electronic device, cause the electronic device to execute an operation of:
based on blocks lastly stored in the nodes being identified as differing from each other, transmitting, to the server, a message requesting a match of the blocks lastly stored in the nodes.

16. An electronic device corresponding to one node of nodes included in a blockchain network, the electronic device comprising:
communication circuitry;
at least one processor comprising processing circuitry; and
memory configured to store instructions,
wherein the instructions, when executed by the at least one processor individually or collectively, cause the electronic device to:
receive, using the communication circuitry, information on a block lastly stored in the nodes included in the blockchain network, wherein the information is transmitted by a server configured to relay message transmissions between the nodes;
based on the identified information on the block, request the server to add a new block in the nodes;
based on identifying, through the server, that a new node has been added to the blockchain network, identify version information for synchronization between the nodes included in the blockchain network through the server;
based on identifying that the version information of the new node is a lower version, transmit information related to a consensus to perform synchronization based on the lower version to the server; and
based on a consensus on adding the new block being successful, add the new block of the lower version to the memory in a state where previously accumulated blocks of a higher version have been removed from the memory.

17. The electronic device of claim 16, wherein the new block of the lower version comprises a key, a newly assigned block number, an updated leaf index, and transaction information including a command of the lower version including a value for the key, and
wherein the newly assigned block number is newly assigned starting from a start number of a next range for a specified block capacity.

18. The electronic device of claim 16, wherein the instructions, when executed by the at least one processor individually or collectively, cause the electronic device to:
generate the transaction information comprising the command of the lower version; and
transmit the generated transaction information and signature information to the server using the communication circuitry.

19. An electronic device that is one node of one or more nodes included in a blockchain network, the electronic device comprising:
communication circuitry;
at least one processor comprising processing circuitry; and
memory configured to store instructions,
wherein the instructions, when executed by the at least one processor individually or collectively, cause the electronic device to:
receive, using the communication circuitry, information on a block lastly stored in each of nodes included in the blockchain network, wherein the information is transmitted by a server configured to relay message transmissions between the nodes;
based on synchronization between the nodes having failed, identify a stable number and an unstable number;
based on blocks of a second node having the stable number, recover a block of a first node having the unstable number, the block of the first node to have a stable number during a next consensus and synchronization;
request, through the server, a consensus to add a new block to each of the nodes, based on the stable number; and
based on the consensus being successful, add the new block to the memory.

20. The electronic device of claim 19, wherein the instructions, when executed by the at least one processor individually or collectively, cause the electronic device to:
based on a block number of the next consensus matches the unstable number, add a dummy block corresponding to the unstable number and request a consensus by using a number next to the unstable number.
